(19) United States
(12) Patent Application Publication
(10) Pub. No.: US 2023/0207926 A1
(43) Pub. Date: Jun. 29, 2023

(54) BATTERY PACK

(71) Applicant: Edge Mobility Ltd, Harrow, London, Greater London (GB)

(72) Inventors: Arjun MEHTA, London, Greater London (GB); Sean CLEARY, London, Greater London (GB)

(73) Assignee: Edge Mobility Ltd, Harrow, London, Greater London (GB)

(21) Appl. No.: 17/927,041

(22) PCT Filed: May 21, 2021
(86) PCT No.: PCT/GB2021/051256

§ 371 Date: Nov. 22, 2022

(30) Foreign Application Priority Data
May 22, 2020 (GB) 2007693.1
Jun. 12, 2020 (GB) 2008998.3

(51) Int. Cl. H01M 10/6568; H01M 50/213; H01M 50/289; H01M 10/6551; H01M 10/613

(52) U.S. Cl. CPC H01M 10/6568; H01M 50/213; H01M 50/289; H01M 10/6551; H01M 10/613

(57) ABSTRACT

a There is disclosed a battery pack comprising: a first battery cell layer comprising a structure for locating battery cells and providing a flow path for a coolant so that the coolant passes across the battery cells; a gasket of a first gasket type located adjacent a first face of the first battery cell layer; and a gasket of a second gasket type located adjacent a second face of the first battery cell layer. Each of the first gasket type and the second gasket type comprises a first side and a second side. The first gasket type comprises holes for the coolant located on the first side of the first gasket type; and the second gasket type comprises holes for the coolant located on the second side of the second gasket type. The gaskets enable the coolant to flow from a first end of the battery pack to a second end of the battery pack via the flow path.

### FIELD OF THE INVENTION

The invention relates to a battery pack. The invention further relates to: vehicles with battery packs; methods of cooling battery packs; methods of making battery packs; and methods of recycling battery packs.

### BACKGROUND

Battery powered vehicles are a large field of research, development and commercialisation now. Battery packs comprise multiple, often many, battery cells connected to produce an electrical output. It is known to want to keep the temperature of the cells in a battery pack within a certain temperature range to maximise performance, longevity and safety.

One known system is that disclosed in US patent publication US10530022B2, shown in FIG. 1 of this application. This system has a plurality of electrical energy storage cells 101, each including a positive terminal and a negative terminal, the cells being arranged in a package or housing 103 containing a dielectric liquid 105. Within the package 103 is provided a controllable stirring device 107 (comprising a propeller 109 driven by a motor 111) for circulating the dielectric liquid 105 in contact with the positive and negative terminals of the cells 101 and a stirring device controlling battery management device 113 capable of detecting a possible failure of a cell 101 and of accordingly controlling the stirring device 107 to modify the dielectric liquid circulation conditions in the package 103. A heat exchanger 205 is provided as part of a cooling circuit 201 connected to the housing 103 by connecting fluid inlet and outlet openings 103b, 103a, with a pump provided at the outlet opening 103a.

Chinese patent publication CN105846009A, shown in FIG. 2, is another disclosure of a battery pack 1′ having many cylindrical battery cells 3 held inside a housing 2 that are cooled by a dielectric insulator fluid 6. The system also has an external fluid pump 10 and heat exchanger cooling devices 4, 8 to which the fluid is routed via pipework, and a pressure control valve 9 to vent fluid 6 if the pressure in the battery pack 1′ rises too much. The cylindrical battery cells 3 are arranged in a grid with spaces between them and the housing 2 has a fluid inlet 5 directing fluid to the spaces between rows of battery cells, and a fluid outlet 7 collecting fluid from the rows between cells, the fluid 6 being pumped past the cells 3 in one direction and returning in the opposite direction, the cylindrical cells 3 touching each other to define channels for fluid flow.

### STATEMENTS OF INVENTION

According to an aspect of the present disclosure, there is described a battery pack comprising: a first battery cell layer comprising a structure for locating battery cells and providing a flow path for a coolant so that the coolant passes across the battery cells; a gasket of a first gasket type located adjacent a first face of the first battery cell layer; and a gasket of a second gasket type located adjacent a second face of the first battery cell layer; wherein each of the first gasket type and the second gasket type comprises a first side and a second side; and wherein: the first gasket type comprises holes for the coolant located on the first side of the first gasket type; and the second gasket type comprises holes for the coolant located on the second side of the second gasket type; whereby the gaskets enable the coolant to flow from a first end of the battery pack to a second end of the battery pack via the flow path.

Preferably, the battery pack comprises a plurality of battery cell layers, wherein each battery cell layer comprises a structure for locating battery cells and providing a flow path for a coolant so that the coolant passes across the battery cells.

Preferably, at least two of, and preferably each of, the plurality of battery cell layers have a gasket of the first gasket type located adjacent a first face of said layer and a gasket of the second gasket type located adjacent a second face of said layer.

Preferably, the first face and the second face are opposing faces.

Preferably, at least one pair of, and preferably each pair of neighbouring battery cell layers has a gasket of a third gasket type located between said pair of battery cell layers, wherein the third gasket type comprises holes for the coolant located on both the first side and the second side of the third gasket type.

According to an aspect of the present disclosure, there is described a battery pack comprising: a first battery cell layer and a second battery cell layer, wherein each battery cell layer comprises a structure for locating battery cells and providing a flow path for a coolant so that the coolant passes across the battery cells; a gasket of a first gasket type located adjacent an outer face of the first battery cell layer; a gasket of a second gasket type located adjacent an outer face of the second battery cell layer; and a gasket of a third gasket type located between inner faces of the first battery cell layer and the second battery cell layer; wherein each of the first gasket type, the second gasket type, and the third gasket type comprises a first side and a second side; wherein: the first gasket type comprises holes for the coolant located along the first side of the first gasket type; the second gasket type comprises holes for the coolant located on the second side of the second gasket type; the third gasket type comprises holes for the coolant located on both the first side and the second side of the third gasket type; whereby the gaskets enables the coolant to flow from a first end of the battery pack to a second end of the battery pack via the flow paths.

Preferably, the battery pack comprises a plurality of battery cell layers. Preferably, a gasket of the third gasket type is located between each pair of battery cell layers.

Preferably, the battery pack comprises at least three battery cell layers, at least five battery cell layers and/or at least ten battery cell layers.

Preferably, each battery cell layer comprises a scaffolding.

Preferably, each scaffolding comprises a lower scaffolding part and an upper scaffolding part.

Preferably, each scaffolding comprises a plurality of channels, wherein each channel is arranged to locate a plurality of battery cells and to provide a flow path for a coolant so that the coolant passes across the cells. Preferably, each scaffolding comprises at least three channels, at least six channels, and/or at least ten channels.

Preferably, the gaskets are arranged such that coolant is able to flow through the holes in each gasket and into and/or out of the channels of (e.g. the scaffolding of) each battery cell layer.

Preferably, the scaffoldings and the gaskets are together arranged to define a flow path for the coolant. Preferably, the direction of flow of coolant through the holes of the gaskets is substantially perpendicular to the direction of flow of coolant through the channels of the scaffoldings.

Preferably, the battery cell layers and the gaskets are arranged to form a stack within the battery pack.

Preferably, the battery pack is arranged such that the pressure of the coolant at the first side of the battery pack is greater than the pressure of the coolant at the second side of the battery pack, such that the coolant flows from the first side of the battery pack to the second side of the battery pack.

Preferably, each battery cell layer and each gasket is located within the enclosure.

Preferably, each battery cell layer comprises a housing segment, wherein the housing segments are arranged to cooperate so as to form part or all of the enclosure of the battery pack.

Preferably, the scaffolding of each battery cell layer is located within the housing segment of said battery cell layer.

Preferably, the housing segment of each battery cell layer comprises a structure for locating a gasket adjacent said housing segment.

Preferably, the gaskets between each pair of battery cell layers form a seal between said pair of battery cell layers. Preferably, the gaskets form a seal between a/the housing segments of said pair of battery cell layers.

Preferably, the battery pack comprises a first end plate. Preferably, the first end plate is located adjacent to a gasket of the first type or a gasket of the second type.

Preferably, the first end plate comprises a structure for locating a gasket adjacent the first end plate such that said gasket forms a seal between the first end plate and one of the battery cell layers. Preferably, the gasket forms a seal between the first end plate and a/the housing segment of one of the battery cell layers.

Preferably, the first end plate comprises a reservoir arranged to accommodate an expansion of the coolant due to temperature fluctuations when the battery pack is in use.

Preferably, the first end plate comprises a vent arranged to: provide an outlet for air to accommodate expansion of the coolant when the temperature of the coolant increases; and/or provide an inlet for air to accommodate compression of the coolant when the temperature of the coolant decreases.

Preferably, the first end plate comprises a plurality of first end plate channels. Preferably, the first end plate channels correspond to channels in the battery cell layer(s). Preferably, the first end plate channels are arranged such that the coolant is able to flow from a/the pump to the holes of a gasket, preferably the gasket of the first type or the gasket of the second type, via the first end plate channels.

Preferably, the first end plate channels are arranged such that, in use, the volumetric flow rate of the coolant through each of the first end plate channels is substantially the same.

Preferably, the first end plate comprises vanes to promote the transfer of heat from the first end plate to the surroundings of the battery pack.

Preferably, the first end plate comprises a pump, which pump is arranged to promote the flow of the coolant through the battery pack.

Preferably, the battery pack comprises a second end plate. Preferably, the second end plate is located adjacent to a gasket of the first type or a gasket of the second type.

Preferably, the second end plate comprises a structure for locating a gasket adjacent the second end plate such that said gasket forms a seal between the second end plate and one of the battery cell layers. Preferably, the seal forms between the second end plate and a/the housing segment of one of the battery cell layers.

Preferably, the second end plate comprises a plurality of second end plate channels. Preferably, the second end plate channels correspond to channels in the one or more battery cell layers. Preferably, the second end plate channels are arranged such that the coolant is able to flow from the holes of a gasket, preferably the gasket of the first type or the gasket of the second type, to a/the pump via the second end plate channels.

Preferably, the second end plate channels are arranged such that, in use, the volumetric flow rate of the coolant through each of the second end plate channels is substantially the same.

Preferably, the second end plate comprises vanes to promote the transfer of heat from the second end plate to the surroundings of the battery pack.

Preferably, the second end plate comprises a pump, which pump is arranged to promote the flow of the coolant through the battery pack.

Preferably, the battery pack is arranged so that, in use, the pump is located at the bottom of the battery pack.

Preferably, the pump is located internally to the battery pack.

Preferably, the pump comprises a surface mounted pump. Preferably, the pump comprises a surface mounted pump having a mounting flange and a pump body attached to the mounting flange.

Preferably, the pump is mounted to the exterior of a/the first end plate and/or a/the second end plate. Preferably, the pump is mounted so that, in use, the coolant flows vertically upwards when leaving the pump.

Preferably, the battery pack is arranged so that, in use, the pump is located at the bottom of the battery pack.

Preferably, the battery pack is arranged such that, in use, the coolant flows from a first end of the battery pack to a second end of the battery pack via the gaskets and the channels.

Preferably, one or more of the gasket types, and preferably each of the gasket types, comprises a fluid return hole. Preferably, the battery pack is arranged such that the coolant flows from the second end of the battery pack to the first end of the battery pack via the fluid return holes.

Preferably, each fluid return hole is located on a third side of said gasket types.

Preferably, each fluid return hole is arranged such that the coolant is able to flow through the fluid return holes to a/the pump.

Preferably, the enclosure comprises a fluid return channel that is aligned with the fluid return hole(s), such that coolant is able to flow through the fluid return channel and fluid return hole(s).

Preferably, each housing segment comprises a fluid return channel that is arranged to align with the fluid return hole(s) of the gaskets, such that coolant is able to flow through the fluid return channel(s) and fluid return hole(s).

Preferably, each battery cell layer is associated with, and/or comprises, a busbar and/or a cover.

Preferably, the busbar and/or the cover comprises transfer holes and/or cut-outs, preferably wherein the transfer holes and/or cut-outs are arranged to align with the holes on the first gasket type, the second gasket type, and/or the third gasket type when the battery pack is assembled.

Preferably, the battery pack comprises one or more temperature sensors.

Preferably, the battery pack comprises one or more temperature sensors located at the exits of one or more channels of one or more battery cell layers. Preferably, the temperature sensors are located at the exits of one or more channels of a/the scaffolding of said battery cell layers.

Preferably, the battery pack comprises one or more temperature sensors located at the entrances of one or more channels of one or more battery cell layers. Preferably, the temperature sensors are located at the entrances of one or more channels of a/the scaffolding of said battery cell layers.

According to another aspect of the present disclosure, there is described a battery pack comprising: a battery cell layer comprising a plurality of channels, wherein each channel is arranged to locate a plurality of battery cells and to provide a flow path for a coolant so that the coolant passes across the cells; and one or more temperature sensors located at the entry and/or exit of one or more of the channels.

Preferably, the battery pack comprises a plurality of temperature sensors located at the exits of the channels and one or more temperature sensors located at the entries of the channels, wherein the number of temperature sensors located at the exits is greater than the number of sensors located at the entries.

Preferably, the battery pack comprises the temperature sensors are arranged to: determine a faulty battery cell; and/or determine a temperature distribution in the coolant; and/or control the operation of one or more battery cells, preferably in dependence on the temperature distribution in the coolant; and/or determine a temperature of a battery cell based on a temperature of the coolant; and/or control the operation of the pump, preferably in dependence on the temperature distribution in the coolant.

Preferably, the temperature sensors are mounted on a/the busbar(s) associated with the battery cell layer(s).

Preferably, one or more of the temperature sensors are mounted on an outer face of the busbar(s).

Preferably, one or more of the temperature sensors are mounted on an inner face of the busbar(s).

Preferably, the battery pack comprises a plurality of heating elements. Preferably, the heating elements are distributed across the battery pack so as to provide even heating of the coolant. Preferably, the heating elements are distributed evenly across the battery pack.

According to another aspect of the present disclosure, there is described a battery pack comprising: a battery cell layer comprising a structure for locating battery cells and providing a flow path for a coolant so that the coolant passes across the battery cells; and a plurality of heating elements distributed across the battery pack.

Preferably, the battery pack comprises at least 10 heating elements, at least 30 heating elements, at least 60 heating elements, and/or at least 100 heating elements.

Preferably, the battery pack comprises a plurality of battery cell layers, wherein each battery cell layer is associated with a plurality of heating elements.

Preferably, the heating elements are distributed across a/the busbar(s) associated with the battery cell layer(s).

Preferably, the plurality of heating elements are distributed across an outer face of the busbar(s).

Preferably, the plurality of heating elements are distributed across an inner face of the busbar(s).

Preferably, the heating elements are arranged to operate in dependence on a/the temperature sensor(s) of the battery pack.

Preferably, the battery pack comprises a reversibly sealable hole and a second hole. Preferably, the second hole comprises a/the vent.

According to another aspect of the present disclosure, there is described a battery pack comprising: a battery cell layer comprising a structure for locating battery cells and providing a flow path for a coolant so that the coolant passes across the battery cells; and a reversibly sealable hole and a second hole.

Preferably, the reversibly sealable hole is arranged to cooperate with the second hole in order to aid the insertion of coolant into, and/or the removal of coolant from, the battery pack.

Preferably, the second hole comprises a vent arranged to: provide an outlet for air to accommodate expansion of the coolant when the temperature of the coolant increases; and/or provide an inlet for air to accommodate compression of the coolant when the temperature of the coolant decreases.

Preferably, each of the reversibly sealable hole and the second hole are located on opposite ends of the battery pack.

Preferably, the battery pack comprises a first end plate and a second end plate; wherein the first end plate comprises one of the reversibly sealable hole and the second hole; and wherein the second end plate comprises the other of the reversibly sealable hole and the second hole.

Preferably, the reversibly sealable hole is arranged to be in line with and/or below the lowest liquid level when the battery pack is oriented so that the reversibly sealable hole is at the bottom of the battery pack.

Preferably, the battery pack comprises a sealing structure for reversibly sealing the reversibly sealable hole.

Preferably, the battery pack comprises the coolant.

Preferably, the coolant is a non-electrically conductive coolant, and/or a dielectric coolant, and/or a liquid coolant.

According to another aspect of the present disclosure, there is described a method of manufacturing the battery pack of any preceding claim.

Preferably, the method comprises: providing a first gasket; and lowering the first battery cell layer onto the first gasket. Preferably, the first gasket is a gasket of the first type.

Preferably, the method comprises providing a first end plate; wherein providing the first gasket comprises lowering the first gasket onto the first end plate.

Preferably, the method comprises deforming the first gasket so as to form a seal between the first end plate and the first battery cell layer. Preferably, deforming the first gasket so as to form a seal between the first end plate and a/the housing segment of the first battery cell layer.

Preferably, the method comprises lowering a second gasket onto one of the battery cell layers. Preferably, the second gasket is a gasket of the second type.

Preferably, the method comprises lowering a second end plate onto the second gasket.

Preferably, the method comprises deforming the second gasket so as to form a seal between the second end plate and the said battery cell layer. Preferably, deforming the second gasket so as to form a seal between the second end plate and a/the housing segment of said battery cell layer.

Preferably, the method comprises identifying a number of battery cell layers to use in the battery pack.

Preferably, the battery pack comprises more than one battery cell layer.

Preferably, the method comprises: lowering a third gasket onto the first battery cell layer; and lowering a second battery cell layer onto the third gasket. Preferably, the third gasket is a gasket of the third type.

Preferably, the method comprises: lowering alternately a plurality of gaskets and a plurality of battery cell layers onto the first battery cell layer such that each pair of neighbouring battery cell layers has one of the plurality of gaskets located between said pair of battery cell layers. Preferably, each of the plurality of gaskets is a gasket of the third type.

Preferably, the method comprises deforming each gasket so as to form a seal between the two battery cell layers adjacent said gasket. Preferably, deforming each gasket between a/the housing segments of said battery cell layers.

Preferably, the method comprises securing together one or more battery cell layers of the battery pack so as to form a part of, and/or all of, an enclosure. Preferably, securing the battery cell layers comprises inserting a fixing structure, e.g. a screw, through each of the battery cell layers, preferably through a/the housing segments of said battery cell layers.

Preferably, the method comprises forming each battery cell layer by: providing a housing segment; lowering a scaffolding into the housing segment; lowering a busbar onto the scaffolding. Preferably, the method comprises making connections between the cells and the busbar. Preferably, the method comprises lowering a cover onto the busbar.

Preferably, the scaffolding comprises a lower scaffolding part and an upper scaffolding part. Preferably, lowering the scaffolding into the housing segment comprises: lowering the lower scaffolding part into the housing segment; lowering battery cells into the lower scaffolding part; and lowering the upper scaffolding part onto the lower scaffolding part and/or onto the battery cells.

According to another aspect of the present disclosure, there is described a scaffolding for the aforesaid battery pack.

According to another aspect of the present disclosure, there is described a gasket for the aforesaid battery pack. Preferably, the gasket comprises a gasket of the first type, or a gasket of the second type, or a gasket of the third type.

According to another aspect of the present disclosure, there is described the first end plate of the aforesaid battery.

According to another aspect of the present disclosure, there is described an end plate for a battery pack, the end plate comprising: a pump, which pump is arranged to promote the flow of a coolant through the battery pack; a reservoir arranged to accommodate an expansion of the coolant due to temperature fluctuations when the battery pack is in use; and vanes to promote the transfer of heat from the end plate to the surroundings of the battery pack.

Preferably, the end plate comprises a structure for locating a gasket adjacent the end plate such that, in use, said gasket provides a seal between the end plate and a battery cell layer of the battery pack.

Preferably the end plate comprises a vent arranged to: provide an outlet for air to accommodate expansion of the coolant when the temperature of the coolant increases; and/or provide an inlet for air to accommodate compression of the coolant when the temperature of the coolant decreases.

Preferably, the end plate comprises a plurality of end plate channels. Preferably, the end plate channels are arranged such that, in use, coolant is able to flow from a/the pump to the holes of a gasket via the end plate channels.

Preferably, the end plate channels are arranged such that, in use, the volumetric flow rate of coolant through each of the end plate channels is substantially the same.

Preferably, the pump comprises a surface mounted pump.

Preferably, the pump is arranged to be located internally to the battery pack.

According to another aspect of the present disclosure, there is described a kit of parts for a battery pack, the kit of parts comprising: a first battery cell layer comprising a structure for locating battery cells and providing a flow path for a coolant so that the coolant passes across the battery cells; a gasket of a first gasket type; and a gasket of a second gasket type; wherein each of the first gasket type and the second gasket type comprises a first side and a second side; and wherein: the first gasket type comprises holes for the coolant located on the first side of the first gasket type; and the second gasket type comprises holes for the coolant located on the second side of the second gasket type.

According to another aspect of the present disclosure, there is described a kit of parts for a battery pack, the kit of parts comprising: a first battery cell layer and a second battery cell layer, wherein each battery cell layer comprises a structure for locating battery cells and providing a flow path for a coolant so that the coolant passes across the battery cells; a first gasket of a first gasket type; a second gasket of a second gasket type; and a third gasket of a third gasket type; wherein each of the first gasket, the second gasket, and the third gasket comprises a first side and a second side; and wherein: the first gasket type comprises holes for the coolant located on the first side of the first gasket type; the second gasket type comprises holes for the coolant located on the second side of the second gasket type; and the third gasket type comprises holes for the coolant located on both the first side and the second side of the third gasket type.

Preferably, the kit of parts comprises a plurality of battery cell layers.

Preferably, the kit of parts comprises a plurality of gaskets of the third type. Preferably, the kit of parts comprises: at least three battery cell layers and at least two gaskets of the third type; at least five battery cell layers and at least four gaskets of the third type; and/or at least ten battery cell layers and at least nine gaskets of the third type.

According to another aspect of the present disclosure, there is provided a battery pack comprising a housing, a plurality of battery cells held within the housing, a coolant liquid held within the housing and in thermal communication with the battery cells, and a pump having a pump liquid inlet and a pump liquid outlet. The pump is mounted to the housing and configured to promote fluid flow in the coolant contained within the housing, there being no separate pipes communicating the pump with the housing.

The pump may be a surface mounted pump having a manifold and a pump body attached to the manifold.

The housing has a housing wall and a liquid outlet aperture may extend through the housing wall, and a liquid inlet aperture may extend through the housing wall;

The manifold may be attached to the exterior of the housing wall so that the housing liquid outlet aperture is aligned with and communicates with the pump liquid inlet and so that the housing liquid inlet aperture is aligned with and communicates with the pump liquid outlet.

The pump may be an internally mounted pump such that the pump is contained within the housing, and the pump may be submerged in the coolant liquid.

The pump may be a surface mounted pump, mounted to an internal surface of the housing, and may have a mounting flange and a pump body attached to the mounting flange.

The housing may have an internal wall and a liquid outlet aperture extending through the internal wall, and a liquid inlet aperture extending through the internal wall.

The mounting flange may be attached to the internal wall of the housing so that the pump is contained within the housing and so that the housing liquid outlet aperture is aligned with and communicates with the pump liquid inlet and so that the housing liquid inlet aperture is aligned with and communicates with the pump liquid outlet.

The pump may be orientated in use at an angle below the horizontal so that air tends to rise away from the pump, so as to minimise the likelihood of an air pocket accumulating inside it. This may be achieved by orientating the whole battery pack so as to achieve the effect.

The pump liquid inlet and outlet may be provided in a face of the manifold, abutting a surface of the housing.

The battery pack may comprise an internal construction and wherein the internal construction is configured to separate coolant flow going to the pump liquid inlet from coolant flow coming from the pump liquid outlet and/or direct coolant flow into internal channels.

The internal construction may comprise internal walls, ribs, formations and/or protrusions of the housing, and/or a scaffolding.

According to another aspect of the present disclosure, there is provided a battery pack comprising a housing, a plurality of battery cells held within the housing, a non-electrically conductive coolant liquid held within the housing and surrounding the battery cells, a surface—mounted pump having a mounting flange and a pump body attached to the mounting flange, the pump having a pump liquid inlet at the flange and a pump liquid outlet at the flange, the housing having a housing wall and a liquid outlet aperture extending through the housing wall, and a liquid inlet aperture extending through the housing wall, the mounting flange being attached to the exterior of the housing wall so that the housing liquid outlet aperture is aligned with and communicates with the pump liquid inlet and so that the housing liquid inlet aperture is aligned with and communicates with the pump liquid outlet, there being no separate pipes communicating the pump with the housing.

It will be appreciated that the provision of the pump flange-mounted directly on the outer surface of the housing wall is an efficient and simple arrangement that eliminates pipework between the housing and the pump, reducing the opportunity for leaks and pipes to damage in use. By having just one inlet hole for liquid from the pump and one outlet hole taking liquid to the pump, opportunities for leaks are minimised.

The pump liquid inlet and outlet may be provided in a face of the flange, adapted to abut a surface of the housing.

The mounting flange may be removably connected to the housing by one or more releasable connectors, such as mounting bolts.

The arrangement also makes repair and replacement of the pump—which can be the only component in the battery pack with moving parts, easy and quick and reliably performed by less skilled workers: unbolting a flange to remove a pump and bolting a flange back on to replace the pump are simple tasks.

The liquid inlet and outlet apertures of the housing may be adjacent to each other, for example there may be about or less than 5 cm between the edge of one aperture and the adjacent edge of the other aperture, possibly about or less than 2 or 3 cm, or about or less than 1 cm.

The battery pack may have a sensor, such as a tilt sensor, to provide a signal to a pump controller which in use controls the operation of the pump and which is adapted to deactivate (or slow down) any fluid flow through the pump when it is determined that the inlet hole of the pump may be surrounded by air instead of coolant liquid, or when there is a danger of that.

The housing may be closed so that the battery pack has a sealed, closed, coolant system.

The housing may comprise a plurality of components held together to form a closed chamber in which the battery cells and coolant liquid are retained.

The housing may comprise a first component and a second component held together to form a closed chamber in which the battery cells and coolant liquid are retained. The two components may be clamped or bolted together and a seal or gasket may be provided between them. The two components may comprise the same or similar shapes held together, or different shapes held together. One component may comprise a bucket or chamber closed off by the other component which may comprise a generally flat wall. Clamping flanges may be provided at cooperating edge regions of the two components. Bolts may be provided at the clamping flanges.

A power transfer terminal extends through the housing to allow electrical power to enter and leave the battery pack.

A temperature sensor may be provided to indicate the temperature of the coolant liquid and the controller may use the temperature sensor to provide input to turn the pump on and off or control the rate of fluid flow through the pump when in use.

A heater or cooler (possibly thermoelectric) may be provided with the housing (preferably inside it) and the controller may use the temperature sensor to activate the heater or cooler to heat or cool the coolant liquid.

The housing may have a volume of between 5 and 30 litres, for example about 10 litres +/—2 litres. The expansion compensation mechanism may be able to accommodate an expansion or contraction of the coolant liquid of about 5%, possibly even 10%.

The pump may be orientated in use at an angle so that air tends to rise away from the pump and out of its liquid inlet or liquid outlet hole, in order to minimise the likelihood of an air pocket accumulating within it.

It will be appreciated that the battery cells are immersed in coolant liquid, with relatively wide flow channels between them, as opposed to spraying liquid onto the cells or having micro channels for coolant liquid. This means that a relatively large volume of coolant liquid is required, which has hitherto been considered a bad idea, but we have realised that the extra expense of the coolant liquid is worth paying for the simplicity and reduced cost of manufacturing and assembling the battery pack.

The coolant liquid may be a specially engineered synthetic fluid, with a kinematic viscosity of under 20 mm²/s, a density of around 1 g/ml, a specific heat of between 1,000 and 2,000 J/kg-K and a dielectric volume resistivity of between 10⁸ and 10¹³ Ohm-cm at room temperature and pressure.

The typical energy capacity of a single system would preferably be under 20 kWh; however, multiple systems can be stacked together to build larger systems.

The total flow rate of the coolant in the system is preferably between 1 and 10 litres per second.

We can also have more than one pump operating in parallel if more flow is needed. An advantage of having a plurality of pumps is that if one becomes inoperative in use the battery pack can still operate on just one pump for a time, albeit at reduced capability. This buys time for a user to repair the battery pack without it being completely useless. This is especially advantageous in the battery pack is powering a vehicle—allowing the vehicle to “limp home”.

According to another aspect of the present disclosure, there is provided a battery pack comprising a housing, a plurality of battery cells held within the housing, a non-electrically conductive coolant liquid held within the housing and surrounding the battery cells, a pump configured to provide flow of the non-electrically conductive coolant liquid within the housing, a scaffolding contained within the housing and configured to locate the battery cells within the housing, and channels configured to provide a flow path for the coolant liquid. The channels direct liquid across one or more surfaces of the battery cells and then across one or more of the internal surfaces of the housing to provide a thermal communication pathway from the cells to an external environment.

The pump may be connected to the housing by pipes, or it may be surface mounted on the housing without separate pipes there between.

An internal construction of the housing and/or the scaffolding and/or the cells may form the channels at least in part.

The internal construction of the housing and the scaffolding may comprise respective and complimentary fitting and/or locating means and the internal construction of the housing and the scaffolding may together form the channels at least in part that direct the coolant liquid across the one or more internal surfaces of the housing.

The internal construction of the housing and the scaffolding may together form inlet and outlet channels that direct the coolant liquid in and out of the housing through a wall of the housing.

The cells and scaffolding may together define a negative space which forms the channels at least in part that direct the coolant liquid across the one or more surfaces of the cells. The negative space may be defined as space within the housing that does not contain components of the battery pack,. In other words, the negative space is space which is able to be filled by the coolant liquid.

The scaffolding may space the cells in order to form gaps between the cells and the gaps may provide the channels at least in part that direct the coolant liquid across the one or more surfaces of the cells.

The scaffolding may space and locate the battery cells so as to provide coolant liquid flow paths past the cells.

The scaffolding may comprise a framework, with apertures through which the coolant liquid is adapted to flow to contact the curved surfaces of the cells. The scaffolding and/or the internal construction of the housing may comprise a framework through which the coolant liquid is adapted to flow to contact the internal surfaces of the housing.

The housing is preferably made of a good thermal conductor, such as metal. The housing may comprise aluminium. The housing may be cast or drawn metal.

The housing may have heat transfer fins, ribs, vanes, projections or other formations on its inside surface to exchange heat with the coolant liquid. The housing may have heat transfer fins, ribs, vanes, projections or other formations on its outside surface to exchange heat with the outside environment. The heat transfer fins, ribs, vanes, projections or other formations may be formed integrally with the housing wall, for example by casting or drawing.

According to another aspect of the present disclosure, there is described a battery pack comprising a housing, a cell scaffolding, a plurality of battery cells held within the cell scaffolding and adapted to be immersed in use in a non-electrically conductive coolant liquid held within the housing and surrounding the battery cells, a surface—mounted pump having a mounting flange and a pump body attached to the mounting flange, the pump having a pump liquid inlet at the flange and a pump liquid outlet at the flange, the housing having a housing wall and a liquid outlet aperture extending through the housing wall, and a liquid inlet aperture extending through the housing wall, the mounting flange being attached to the exterior of the housing wall so that the housing liquid outlet aperture is aligned with and communicates with the pump liquid inlet and so that the housing liquid inlet aperture is aligned with and communicates with the pump liquid outlet, there being no separate pipes communicating the pump with the housing.

A scaffolding for spacing and/or locating the battery cells may be provided inside the housing. The scaffolding spaces and positions the battery cells so as to provide liquid flow paths past the cells. The scaffolding may also itself define part of a liquid flow path. The flow paths may be generally parallel serpentine counter-current flow paths, with the liquid arranged to flow in one direction past a row of cells to one side of the row of cells and in the opposite, return, direction to the other side of the row of cells.

Alternatively the liquid flow paths may cause liquid to flow past the cells of a row of cells in the same direction generally parallel to the rows of cells, from an inlet end to an outlet end for coolant liquid, with the liquid at the outlet end flowing in a direction transverse to the rows of cells, past the ends of multiple rows of cells. The coolant may flow past a cell in a flow path that contacts only one side of a cell, or it may flow past a cell in flow paths that contact opposite sides of a cell.

The battery cells may comprise cylindrical cells and may be of substantially the same size and shape. There may be of the order of 6 to 12, or more cells in a row, and there may be of the order of 6 to 12 or more rows of cells.

The scaffolding may comprise a framework, with apertures through which coolant is adapted to flow to contact the curved surfaces of the cells. The framework may comprise superposed thin strips parallel and spaced apart, with curved recesses into which are located the battery cells.

The scaffolding may be made of plastics material.

As mentioned, the scaffolding may perform the function of positioning, holding or spacing the battery cells and also directing liquid pumped by the pump in a particular flow path or paths.

The scaffolding also takes up a certain volume inside the housing and can serve to reduce the amount of coolant liquid that is needed.

According to another aspect of the present disclosure, there is provided a battery pack comprising a housing, a plurality of battery cells held within the housing, a non-electrically conductive coolant liquid held within the housing and surrounding the battery cells, and a reservoir positioned within the housing. The reservoir is configured to accommodate expansion and contraction of the coolant liquid due to temperature fluctuations when the battery pack is in use.

The battery pack may have a reservoir provided inside the housing adjacent to the top surface of the housing and a pressure release valve provided on the top surface of the housing. The reservoir may be partially filled with air and partially filled with coolant liquid.

The reservoir may be in part defined by a dividing wall or surface extending across the housing and having one or more holes to allow the coolant liquid to pass in and out of the reservoir into the remaining volume of the housing.

The pressure release valve may have a selectively permeable membrane that allows air but not liquid through it. When the coolant liquid inside the housing expands, the pressure inside the housing will increase and the air in the reservoir will be forced out through the pressure release valve. When the liquid inside the housing contracts, the pressure inside the housing will decrease and air will be sucked back into the reservoir through the pressure release valve.

The reservoir may alternatively comprise of a chamber positioned within the housing but above the main body of the housing, and this reservoir may be defined in part by a dividing wall or surface extending across the housing. The chamber may have a smaller plan area when viewed from above the housing than the main body of the housing. The dividing plate may have a one or more holes to allow the coolant liquid to pass in and out of the chamber into the main body of the housing.

Alternatively, or additionally, such a reservoir and pressure release valve may be provided outside of the housing.

An excess pressure burst disc or valve may be provided in the housing wall so as to provide a controlled point of bursting to alleviate any excess pressure if the battery cells undergo venting or if the coolant liquid experiences a pressure above a predetermined critical pressure.

A pump may be provided at or near the top of the chamber. The reservoir may be provided above the pump, either inside or outside of the housing.

The pump may be connected to the housing by pipes, or it may be surface mounted on the housing without separate pipes there between.

The battery pack may further comprise a sensor, wherein the sensor is configured to provide a signal to a pump controller which, when in use, controls the operation of the pump.

The sensor may provide a signal that is indicative of a risk of the pump pumping air or ‘dry pumping’.

The controller may be configured to deactivate or slow the pump when it is determined that there may be a risk of the pump pumping air instead of liquid.

The sensor may be a tilt sensor. The tilt sensor may be configured to provide a tilt value that may be a measure of a magnitude or an acceleration of tilt. The tilt sensor or the controller may determine a risk of pumping air in dependence on the tilt values.

Other sensors for detecting the presence of air within the battery pack or for determining a risk of pumping air may be used.

According to another aspect of the present disclosure, there is provided a battery pack comprising a housing, a plurality of battery cells held within the housing, a non-electrically conductive coolant liquid held within the housing and surrounding the battery cells and a flexible diaphragm fitted into an opening on the surface of the housing. The diaphragm is attached to a piston, which in turn is connected to a spring in order to accommodate expansion and contraction of the coolant liquid due to temperature fluctuations when the battery pack is in use.

The piston and spring may be mounted on the inside of the housing. Alternatively, the piston and spring may be mounted on the outside of the housing.

The stiffness of the spring may be selected to minimise variation in the pressure of the coolant liquid inside the housing as it expands and contracts. When the coolant liquid expands, it may cause the diaphragm to rise and/or stretch increasing the effective volume of the housing till the force of the spring balances the pressure force of the coolant liquid inside. When the coolant liquid contracts, it may cause the diaphragm to collapse and/or relax decreasing the effective volume of the housing till the force of the spring once again balances the pressure force of the coolant liquid inside.

The diaphragm may be fitted into an opening on surface of the housing with a sealed interface so neither air nor liquid can enter or leave.

The diaphragm may be circular in cross-section and about 10 to 15 cm in diameter, and it may stretch till its centre point rises about 5 to 10 cm above the surface of the housing. Of course, the diaphragm may be any other shape or size to accommodate the expansion and contraction of the coolant liquid inside.

According to another aspect of the invention there is provided a battery pack comprising the features of any one or more of the preceding aspects and variants.

According to another aspect of the present disclosure, there is described an electrically powered vehicle having a battery pack in accordance with any of the preceding aspects of the invention. The battery pack may comprise air cooling fins on the outside of the housing aligned generally from the front to the back of the vehicle.

According to another aspect of the present disclosure, there is provided a small electrically powered vehicle, such as a one or two person vehicle, or a small passenger car, or a motorcycle or scooter, or a small electric vehicle with no passengers or an autonomously guided robot, having a battery pack in accordance with any of the preceding aspects of the invention. The battery pack may comprise air cooling fins on the outside of the housing aligned generally front to back of the vehicle. Such vehicles have a normal direction of travel and the orientation of such vehicles is often in a well-controlled generally vertical orientation. We have appreciated that this enables us to have air cooling fins on the outside of the housing that are generally aligned with the direction of travel so as to maximise airflow over the fins in use, and maximise cooling of the coolant liquid.

By “small” we mean that the vehicle weighs between 75 kg and 500 kg and the battery pack has a volume of between 10 litres and 100 litres.

Of course, the vehicle does not have to be small.

We have realised that conventional cars have (relatively) a lot of space for installing cooling circuits and components such as hoses, pressure valves, reservoirs, refrigerant loops, heat exchanger units, pumps etc. when compared with small vehicles, such as motorcycles and other one or two person vehicles. We have realised that we can use the housing of the battery pack itself to exchange heat with the environment, instead of having additional heat exchangers placed outside of it, and connected to fluid within it. Our invention can in some embodiments bring one or more, or all, of reduced volume, reduced assembly cost, reduced number of parts, easier servicing, and a smaller number of interfaces where leaks can occur. The leakage of coolant is of course also associated with the ingress of air into the coolant system.

It will be appreciated that battery cells give out heat most when they are fast charged and discharged. If the battery pack is on a vehicle which is moving, the airflow past the vehicle could be channelled past one or more outer surfaces of the housing to help cool the battery pack.

If the battery pack is stationary, for example being fast charged, or if the battery pack is installed in a vehicle where none of the outer surfaces of the housing are exposed to airflow, then it may be advantageous to cool the battery pack using a cooler either attached to the outer surface of a wall of the housing or held within the housing. The cooler could be a thermoelectric cooler such as a Peltier effect cooler or a plate with heat-pipes or cooling channels embedded. Of course, such a cooler could also be used when the vehicle is moving to cool the battery pack when it is being discharged. Forced convention could also be used to increase heat transfer by installing fans to force air over the outer surfaces of the housing.

The battery pack can in some circumstances be used in a hybrid arrangement where an internal combustion engine or renewable power source—such as wind or photovoltaic power—is used to charge the battery cells. It could be used in a hybrid vehicle.

According to another aspect of the present disclosure, there is described a method of manufacturing a battery pack comprising spacing and holding battery cells within a first battery pack housing component and making a substantially closed battery pack by attaching (e.g. using a seal) one or more additional battery pack housing components to the first component to form a substantially closed battery pack housing, substantially filling the interior of the battery pack with a thermally conductive but electrically non-conductive dielectric coolant liquid, and attaching a surface mounted pump to an outside surface of the battery pack housing in communication with liquid inlet and liquid outlet apertures provided in the housing.

According to another aspect of the present disclosure, there is described a method of cooling battery cells of a battery pack by immersing the cells in a thermally conductive but electrically non-conductive dielectric coolant liquid and using a surface mounted pump mounted directly onto the exterior surface of a coolant-retaining housing to pump coolant fluid within the housing to cause it to flow past the cells and past walls of the housing, thereby transferring heat between the cells and the housing without passing through pipework between the housing and the pump.

According to another aspect of the present disclosure, there is described a method of cooling battery cells of a battery pack provided in a housing of the battery pack by immersing the cells in a thermally conductive but electrically non-conductive dielectric coolant liquid and using a scaffolding to space, position and locate the battery cells within the housing and also to direct liquid to flow past surfaces of the battery cells and then past the internal surfaces of the housing so as to transfer heat between the battery cells and the housing.

According to another aspect of the present disclosure, there is described a method of cooling battery cells of a battery pack provided in a housing of the battery pack by immersing the cells in a thermally conductive but electrically non-conductive dielectric coolant liquid held within the housing and using a reservoir provided at the upper region of the housing with a pressure release valve provided above the reservoir and through the top surface of the housing to accommodate changes of volume of the coolant liquid by allowing the liquid to displace air in the reservoir when the liquid expands and by allowing air to replace the liquid in the reservoir when the liquid contracts.

Recycling

According to another aspect of the present disclosure, there is provided a method of recycling a sealed liquid-cooled battery pack. The sealed liquid-cooled battery pack comprises a housing, battery cells retained within the housing, and a liquid-cooling system. The liquid-cooling system comprises a plurality of components including a coolant liquid contained within the housing and one or more mechanically fitted components, such as a pressure relief valve or vent, a burst disc, a reservoir or a liquid pump, mechanically fitted either on the inside or outside of the housing. The method comprises unsealing the battery pack, extracting the coolant liquid from the battery pack, and reusing at least one of the liquid-cooling system components.

The battery pack is sealed to prevent the egress of the coolant liquid from the battery pack. The sealing also reduces the chances of ingress of dirt, moisture and other contaminants than if the battery pack was unsealed. The battery pack may not be completely airtight, as air and other gases may be allowed to pass to and from the battery pack to the external environment. Unsealing the battery pack comprises unsealing the liquid-cooling system in order to allow for the extraction of the coolant liquid.

The coolant liquid is preferably an electrically non-conductive coolant liquid. The coolant liquid can then be used as a ‘bath’ in which the cells of the battery pack are submerged or surrounded by coolant liquid within the housing. We have appreciated that this method of cooling avoids the use of thermal compounds, resins, adhesives, flexible tubing, and watertight interfaces within the housing as the coolant liquid is in direct contact with one or more surfaces of the cells. As a result, most of the cost of such a liquid-cooling system is in the coolant liquid and the one or more pumps.

The coolant liquid once extracted may be reused in another liquid-cooled battery pack. We have appreciated that the life of the coolant liquid is a lot longer than the predicted life of a liquid-cooled battery, for example for powering a vehicle, and that the cost of the liquid can be a significant part of the cost of a battery pack, of the order of say 10%, or even up to 30% of the cost for example when an electrically non-conductive coolant liquid is used. By reusing the coolant liquid, we can reduce the cost of a new battery pack, and it is also good for the environment.

If a pump is mechanically fitted, for example surface mounted, on the outside of the battery pack it is also an efficient, low cost and quick process to remove the pump and extract the coolant liquid from the housing through the hole left by the removed pump. The pump can then be reused, further lowering the cost of a new liquid-cooled battery pack (again pumps typically have an operational life that far exceeds the maximum performance life of battery cells).

Also, even if the battery cells are not yet degraded in performance, other design improvements in batteries may still limit the useful life of a high-power battery pack, making it desirable in some cases to use a new battery pack.

Reusing components of the battery pack can provide reduced environmental impact as well as commercial benefits. Fewer components being scrapped reduces the manufacturing costs of any subsequent battery packs that make use of the reused components.

The method may further comprise resealing the battery pack.

Resealing the battery pack can allow the battery pack to be operated again whilst protecting the internal components from environmental factors, such as dirt or water/moisture. The battery pack can then be used in a lower power mode than when it was filled with coolant liquid.

At least one of the one or more mechanically fitted components may be fitted to an external surface of the housing. The housing may comprise two or more housing sections sealed together, which remain sealed together during the method.

Resealing the housing can be particularly challenging and require more tools, preparation and processing, and time. Keeping the housing sections sealed together during the method can therefore reduce the workload compared to completely dismantling the battery pack, as may be required in a complete breakdown for material recycling, and can speed up the method.

The method may further comprise removing at least one mechanically fitted component from the battery pack.

Removing the at least one mechanically fitted component may constitute unsealing the battery pack. In other words, removing the at least one mechanically fitted component provides the means through which the coolant liquid can be extracted. Using the removal of the mechanically fitted component to unseal the battery pack reduces step counts and therefore increases efficiency in the process, saving time and requiring less equipment.

The method may further comprise leaving the cells of the battery pack within the housing of the battery pack and using the battery pack as an air-cooled battery pack in applications where liquid-cooling is not required. Whilst the cells degrade over time and are unable to hold as much charge after many discharge and recharge cycles, they are still operable. The cells are perhaps no longer fit for purpose for their original, high-power role (e.g. in a traction battery for a motor vehicle) but can still be utilised in low-power applications (e.g. as a stationary energy storage solution or in a low-speed motor vehicle). Re-using the battery pack as an air-cooled battery pack allows the majority of the battery pack and the cells within it to be repurposed and have its life extended. The high value components of the liquid-cooling system, which may have a longer life than the cells, can then be repurposed into a new, liquid-cooled battery pack.

The mechanically fitted components may comprise a pump and removing the at least one mechanically fitted component from the battery pack may comprise removing the pump from the battery pack.

The method may further comprise replacing the pump with an air pump. The air-cooled battery pack can be kept cooler using air pumps as forced convection can be applied to surfaces within and without the housing. In particular, the air pumps provide air flow over the surfaces of the cells. This raises the heat transfer capabilities over simply using a passive air-cooled system without pumping or circulating any air. The method may comprise communicating a battery pack controller with the air pump to enable it to be controlled.

The mechanically fitted components may comprise a reservoir and removing the least one mechanically fitted component from the battery pack may comprise removing the reservoir from the battery pack.

The method may further comprise mechanically fitting a closure, such as a pressure relief valve or vent to the outside of the housing after removing the reservoir from the battery pack.

The pressure relief valve or vent may be adapted for the pressure and humidity control requirements of the battery pack. In particular, the pressure relief valve or vent may be adapted for the pressure and humidity control requirements of the battery pack when it is an air-cooled battery pack. The pressure relief valve or vent may be communicated with a battery pack controller to enable it to be controlled in use.

The mechanically fitted components may comprise a pressure relief valve or vent and removing at least one mechanically fitted component from the battery pack may comprise removing the pressure relief valve or vent from the battery pack.

The method may further comprise replacing the pressure relief valve or vent with a further pressure relief valve or vent.

The further pressure relief valve or vent may be adapted for the pressure & humidity control requirements of the battery pack. In particular, the pressure relief valve or vent may be adapted for the pressure and humidity control requirements of the battery pack when it is an air-cooled battery pack. The further pressure relief valve or vent may be communicated with a battery pack controller to enable it to be controlled in use.

Removing the at least one mechanically fitted component from the battery may reveal an aperture or plurality of apertures into the interior of the housing. The method may further comprise extracting the coolant liquid using the aperture or one or more of plurality of apertures.

The coolant liquid may be extracted via a plurality of the plurality of apertures simultaneously. Extracting from multiple apertures can improve the flow rate. This therefore increases the speed and efficiency of the method. This may be particularly useful in a production line setting in which multiple battery packs have to be recycled in parallel or sequentially.

Extracting the coolant liquid from the battery pack may comprise sucking the coolant liquid out of the battery pack. In other words the coolant liquid may be actively pumped from the battery pack. Extracting the coolant liquid from the battery pack may comprise pumping air (or other gas) into the battery pack. Pumping air into the battery pack can ensure that a pressure drop within the housing does not occur and a vacuum begin to form. This can further increase the speed and efficiency of the extraction as the pumps pumping the liquid out do not have to work against as great a pressure differential. The air can also be provided in a state where it is suitable for use in the battery pack when it operates in an air-cooled capacity.

The method may further comprise fitting liquid recovery equipment to one or more of the plurality of apertures.

The method may further comprise detecting completion of the extraction of the coolant liquid.

Completion of the extraction of the coolant liquid may be detected by the liquid recovery equipment.

The air or other gas pumped into the battery pack may be dry air and the dry air may be retained within the battery pack when the battery pack is resealed. The air may be ambient air or any suitable gas. The air is preferably dry air. Dry air may be air (or other suitable gas or mixture of gases) having a relative humidity of less than 40%, or less than 25% preferably less than 15%.

The method may further comprise covering the apertures with a cover so as to reseal the battery pack after the coolant liquid has been extracted.

The method may further comprise re-using at least one of the mechanically fitted components within a further battery pack.

The method may further comprise re-using the coolant liquid within a further battery pack. The battery pack may further comprise a controller and a sensor.

The method may further comprise using the controller to limit the charge power accepted by the battery pack or the discharge power extracted from the battery pack when it is used as an air-cooled battery pack to a lower level than it was capable of when it was liquid-cooled, the sensor determining the absence of liquid and the controller using a signal from the sensor to limit the operation of the battery pack.

The method may comprise providing a control input to the controller to cause it to operate the battery pack in a reduced charge/discharge power mode in the future.

Providing the control input may comprise one or more of: reprogramming the controller, operating a switch associated with the controller, and providing a signal from a further controller.

The method may comprise unsealing a reversibly sealable hole in the battery pack so as to enable the flow of fluid out of or into the reversibly sealable hole. Extracting the coolant liquid may comprise extracting the coolant liquid from the reversibly sealable hole and/or pumping air into the a/vent.

The method may comprise orienting the battery pack before extracting the coolant so that the reversibly sealable hole is located at the bottom of the battery pack.

Extracting the coolant liquid may comprise extracting the coolant liquid from a pressure release vent and/or pumping air into the pressure release vent.

According to another aspect of the present disclosure, there is provided a recyclable battery pack. The battery pack comprises a housing, the housing containing fluid pathways for directing an electrically non-conductive coolant liquid around a plurality of cells contained within the housing, one or more apertures in a wall of the housing for receiving releasable components mechanically fixed to the housing, such as a pump, a pressure relief valve, a burst disc and/or a reservoir, and a cover, for closing (e.g. using a seal) the one or more apertures. The cover may be a new component, for example an air pump.

The battery pack may comprise a controller, the controller may be configured to determine the presence, or lack, of a coolant liquid contained within the housing, and to control operation of the battery pack in dependence on the determination.

If the controller determines that coolant liquid is not present within the housing then the controller may operate the battery pack in a low-power configuration.

If the controller determines that coolant liquid is present within the housing then the controller may operate the battery pack in a high-power configuration.

The controller may determine the presence, or lack, of a coolant liquid contained within the housing, by receiving a signal from an operator during a recycling process.

The controller may determine the presence, or lack, of a coolant liquid contained within the housing, by receiving a signal from a switch.

The controller may determine the presence, or lack, of a coolant liquid contained within the housing, by receiving a signal from a sensor within the housing.

According to another aspect of the present disclosure, there is described a battery arrangement comprising a plurality of the aforesaid battery packs. Preferably, the battery packs are arranged such that vanes on the outside of each battery pack are aligned and/or parallel.

Preferably, the battery arrangement comprises a plurality of rows of battery packs and/or a plurality of columns of battery packs.

Preferably, the battery arrangement comprises an electrical connector arranged to connect the battery packs of the battery arrangement. Preferably, the electrical connector is arranged to control the battery packs of the battery arrangement.

According to another aspect of the present disclosure, there is described a vehicle comprising the aforesaid battery pack and/or the aforesaid battery arrangement. Preferably, the vehicle comprises one or more of: a road vehicle; a motorbike; a marine vehicle; a single seater vehicle; a two seater vehicle; and a three seater vehicle.

As used herein, the term ‘gasket’ preferably connotes any component that provides a passage for the flow of a fluid and blocks the flow of fluid through the gasket other than through this passage. Therefore, a gasket may comprise a flat sheet of material with a hole where fluid is able to flow through this hole and not through the remainder of the gasket. Typically, a gasket is arranged to be located between two surfaces, where the gasket is typically arranged to provide a seal that prevents the flow of fluid from these surfaces into the environment and prevents the flow of fluid from this environment into these surfaces (while allowing the flow of fluid between the two surfaces via the passage). The gasket may be deformable, where the gasket deforms as the two surfaces are pressed together in order to form a seal.

### BRIEF DESCRIPTION OF THE DRAWINGS

Embodiments of the invention will now be described by way of example, with reference to the accompanying drawings of which:

FIGS. 1 and 2 show prior art battery packs;

FIG. 3 shows schematically a battery pack in accordance with an embodiment of the present disclosure;

FIG. 4a shows schematically a pump for use with the battery pack of FIG. 3;

FIG. 4b shows schematically a cross-sectional view of the pump of FIG. 4a;

FIG. 4c shows schematically a portion of a housing of the battery pack of FIG. 3;

FIG. 4d shows schematically a cross-section view of the pump of FIG. 4a and a portion of the housing;

FIG. 5a shows a schematic view of the battery pack of FIG. 3 with a closure cover removed;

FIG. 5b shows a schematic view in more detail of battery cells and a scaffolding within the battery pack of FIG. 3;

FIG. 6 shows a schematic view of the flow of coolant within an embodiment of the battery pack;

FIG. 7a shows schematically a cross-sectional view of an arrangement for compensating for expansion of coolant liquid;

FIG. 7b shows schematically a component for use in the arrangement of FIG. 7a;

FIGS. 8a, 8b and 8c show schematically a cross-section view of a further arrangement for compensating for expansion of coolant liquid;

FIGS. 9a, 9b, 9c, and 9d show an embodiment of a lower part of a scaffolding for locating the battery cells;

FIGS. 10a, 10b, 10c, and 10d show an embodiment of an upper part of the scaffolding and a busbar;

FIGS. 11a and 11b show exemplary flow paths for a coolant in an embodiment of a battery pack that comprises three types of gaskets;

FIGS. 11c, 11d, and 11e show types of gaskets that may be used in the battery pack of FIGS. 11a and 11b;

FIGS. 11f and 11g show exemplary flow paths for a coolant in another embodiment of a battery pack that comprises three types of gaskets;

FIGS. 11h and 11i show exemplary flow paths for the coolant through the gaskets of the battery packs of 11a, 11b, 11f, and 11g;

FIGS. 12a-12f show exemplary flow paths for a coolant in a battery pack that comprises two types of gaskets;

FIGS. 13a, 13b, 13c, and 13d show an embodiment of a bottom end plate of the battery pack;

FIGS. 14a and 14b show an embodiment of a top end plate of the battery pack;

FIG. 15 shows an embodiment of a battery pack according to the present disclosure;

FIGS. 16a and 16b show battery arrangements formed of a plurality of battery packs;

FIGS. 17a and 17b show, respectively, another embodiment of a battery pack and another embodiment of a battery arrangement;

FIGS. 18a and 18b show a battery cell layer that comprises temperature sensors;

FIG. 18c shows a battery cell layer that comprises distributed heating elements;

FIGS. 19a and 19b show schematically a motorcycle or scooter having a battery pack in accordance with the present disclosure;

FIG. 20 shows schematically a design variation of a battery pack according to the present disclosure;

FIG. 21 shows schematically the battery pack of FIG. 20 converted to an air-cooled configuration;

FIG. 22 shows schematically an arrangement of a battery pack with a liquid recovery apparatus;

FIG. 23 shows a flow diagram for recycling routes of a battery pack in accordance with the present invention;

FIG. 24 shows a method of recycling a battery pack according to the present invention;

FIG. 25 shows another method of recycling a battery pack according to the present invention; and

FIG. 26 shows a method of extracting coolant liquid from a battery pack for use in the method of FIG. 24 of FIG. 25.

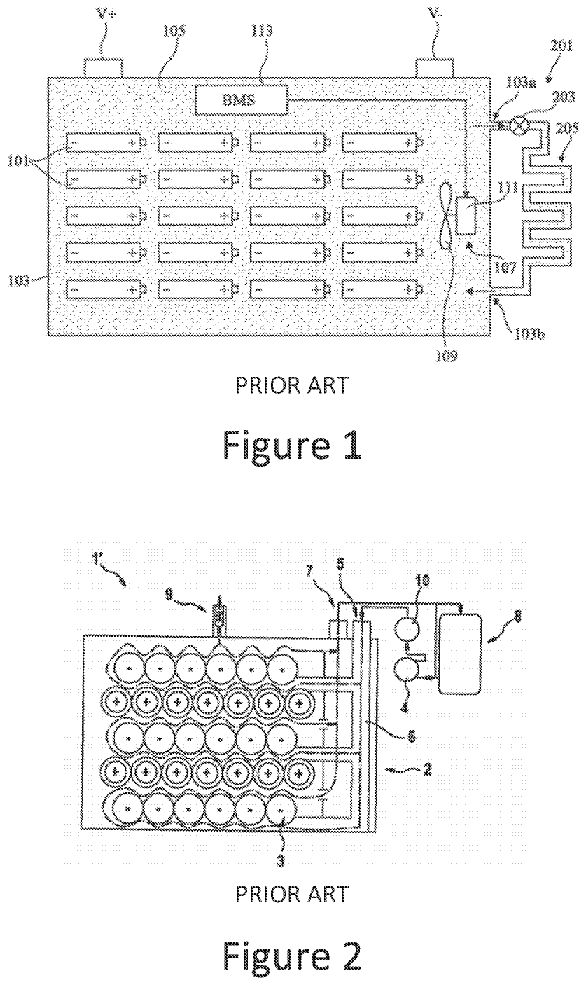

### DETAILED DESCRIPTION

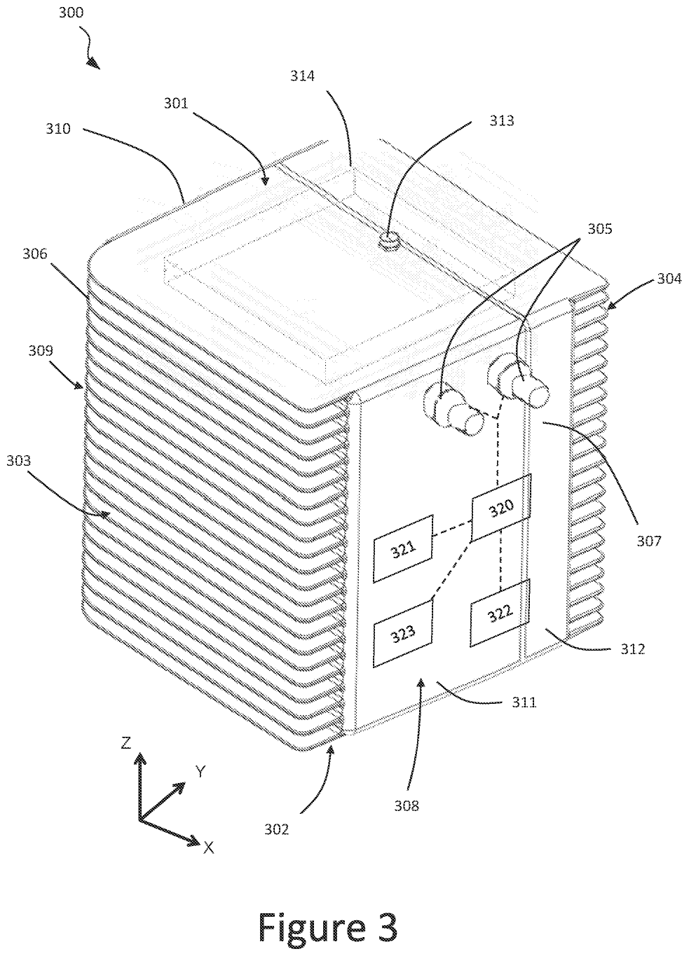

A battery pack 300 is shown schematically in FIG. 3. For ease of description the battery pack is described by reference to the three axes X, Y and Z and has a top 301, bottom 302, left side 303 right side 304, back 308 and front 309. These labels are with respect to a preferred orientation of the battery pack when in-use. However, the battery pack may be orientated differently; for example in rotation around the Z axis such that the front and back may be reversed or the front and back may become the left and right. The battery pack comprises a sealed housing 310 with a bath of liquid coolant 307 contained within the housing 310. A plurality of cells is fully immersed within the bath of liquid coolant 307. The liquid coolant 307 regulates the temperature of the cells.

The housing 310 is made from a plurality of parts including at least two parts 311, 312. The two parts consist of a left part 311 and a right part 312. The two parts 311, 312 are sealed mechanically to form the housing 310 such that no air or liquid can enter or escape to or from within the housing at the points at which the two parts are joined. The liquid coolant 307 is therefore prevented from leaking from the battery pack, and contaminants, such as moisture, are prevented from entering. The mechanical connection is achieved through bolting the two parts together, with a gasket or O-ring provided between them in order to provide the sealing. Other mechanical joining and sealing means may be used. The housing can be scaled in a lateral direction (i.e. along the Y axis) through the replacement of one or both of the two parts 311, 312 with longer or shorter variants or the addition of one or more centre sections between 311 and 312. In this manner the housing 310 can be scaled for various use cases, for example different sized forms of transport or different energy storage requirements. With longer battery packs additional pumps 305 can be added in parallel. Additional pumps can increase liquid volume flow as discussed below.

In an alternative example the housing comprises a top or lid affixed to a “bucket” housing, possibly with a gasket or seal and bolts. In other examples the housing may be formed from more than two parts, for example a bottom section, a centre section and a top lid. All the parts are sealed together such that no air or liquid can enter or escape to or from within the housing at the points at which the parts are joined.

An internal reservoir 314 is provided at the top of the battery pack and a pressure relief valve 313 is provided above the internal reservoir 314 in the top surface 301 of the battery pack. The reservoir and pressure relief valve together allow the liquid coolant 307 to expand and contract when the temperature increases or decreases. Whilst the reservoir and pressure relief valve are shown in the top 301 of the battery pack in this example, they may alternatively be situated elsewhere above the main body of the housing.

A burst disc may also be provided to provide an emergency pressure release in case of pressure fluctuations being too large for the reservoir and pressure release valve to accommodate. The burst disc may be provided in a flat wall, and preferably on the bottom 302 of the housing so that any coolant liquid that is released from the pack can be more readily directed away from the pack, and away from any passengers should the pack be installed in a vehicle, rather than being allowed to pool on the surface or otherwise run along surface as may be the case if the burst disc is situated on the top or sides of the pack.

The housing 310 is configured to act as a heat exchanger. The walls of the housing 310 are made (at least in part) from a thermally conductive material such as metal. The thermally conductive material improves the rate of heat transfer from the coolant within the housing 310 to the environment outside of it. This improves temperature regulation over a battery pack that uses thermally insulating materials. The material is also minimally reactive or non-reactive and is therefore protected from reacting with the liquid coolant 307 within the housing 310 or the environment without it. A suitable material may be aluminium for example. Ribs, vanes, and/or fins 306 are also provided on one or more of the external surfaces of the housing 310. The fins 306 increase the external surface areas of the housing 310, therefore increasing heat transfer from the housing to the external environment. In use cases in which the battery pack is to be mounted on a vehicle, the fins can be arranged such that they run in parallel to the intended predominant direction of travel of the vehicle. In this way air flow can pass along the fins as the vehicle moves, further increasing heat transfer. Ribs, vanes, and/or fins can also be provided on one or more of the internal surfaces of the housing, thereby increasing the internal surface area of the housing and therefore increasing heat transfer from the bath of liquid coolant to the housing, from where the heat can be dissipated into the environment.

Additional, active heat transfer means may optionally also be provided. For example, a Peltier cooler or cooling plate with heat pipes may be provided on a surface of the housing. Fans may also be used to provide forced air convention across the surface of the housing 310. Optional features such as this can further improve heat transfer and the dissipation of excess heat from within the housing.

A controller 320, temperature sensor 321 and tilt sensor 322 are provided. The controller 320 is in communication with the pumps 305 and configured to control their operation. The controller determines the operation of the pumps 305 in dependence on inputs received from the temperature sensor 321 and the tilt sensor 322. The temperature sensor is positioned such that it can measure a temperature of the liquid coolant 307 within the housing 310. Alternatively, the temperature sensor may be situated elsewhere in or on the housing. The temperature sensor may be configured and positioned to measure a temperature of the housing or other part of the battery pack, a temperature of the liquid coolant may then be inferred from the measured temperature, and the control of the pumps may then be implemented based on the measured temperature. Multiple temperature sensors are preferably used in order to take temperature readings at different positions of the battery pack. The tilt sensor is arranged to measure a variation in one or both of pitch (angular movement about the Y axis in this example) and roll (angular movement about the X axis in this example). Multiple tilt sensors may be used in order to measure the different tilt about different axes. Measuring tilt may comprise measuring a magnitude and/or an acceleration of tilt. Measuring the tilt of the battery pack may allow the controller to 320 determine the likelihood of the pumps 305 being affected by air pockets and the risk of dry pumping, which can cause damage to the pumps 305. If tilt over a certain threshold occurs, at which air pockets are likely to interfere with the pumps, then the controller may temporarily pause or deactivate the pumps 305. This therefore provides increased durability of the device during use, particularly in vehicles (two-wheeled vehicles even more so) which may be subject to large tilt variations.

In order to mitigate the risk of air accumulating within the pumps 305, the battery pack can be mounted or installed such that the pumps have an axis that is non-horizontal and the liquid inlet and/or liquid outlet holes of the pump are displaced vertically above the body of the pump. This can prevent air bubbles accumulating within the pumps, which may occur if the pumps are horizontal. In some examples the walls of the housing are inclined, such that the housing tapers from top to bottom. The surface mounted pumps therefore are also inclined upwards within the housing. In other examples the pumps may be constructed such that a body of the pump has an axis that is non-orthogonal to a plane of a flange of the pump, such that the pump is naturally inclined when installed on a vertical face.

The tilt sensors 322 may comprise or be supplemented by accelerometers. As changes in acceleration may result in ‘sloshing’ of the coolant liquid and displacement of air within the housing, the use of accelerometers can also be used to provide inputs to the controller in order to control the operation of pump 305.

The pumps 305 and other components are typically mounted on the external surface of the housing 310 in order to facilitate easier servicing and repairs than if the components were fixed internally to the housing 310. Whilst the majority of components are fitted to the surface of the housing the number of components requiring cut-outs or holes in the walls of the housing is kept as low as possible. As each of these require sealing, this therefore reduces the risks of a sealing failure.

In some configurations a single pump may be used, however multiple pumps are preferred. Multiple pumps provide increased volumetric flow as well as redundancy in case of failure of any one of the pumps.

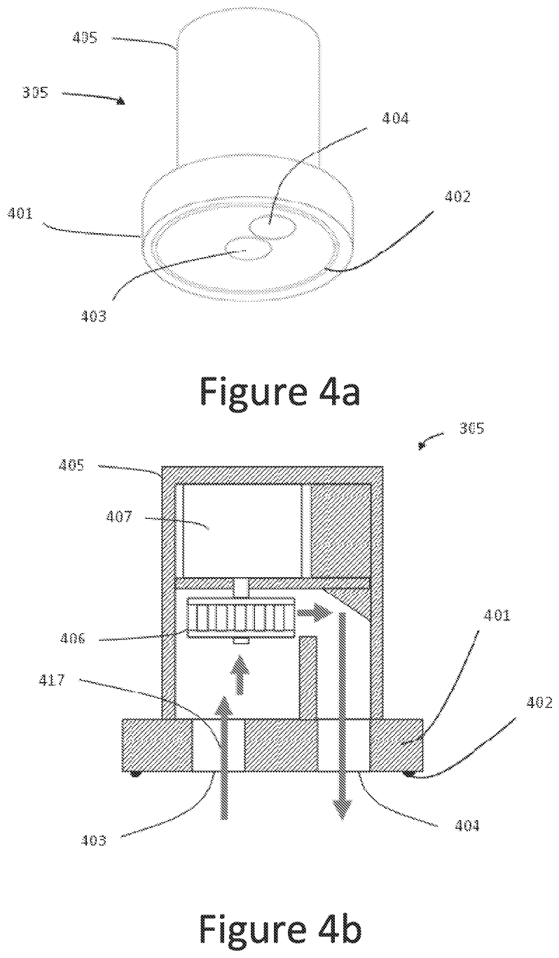

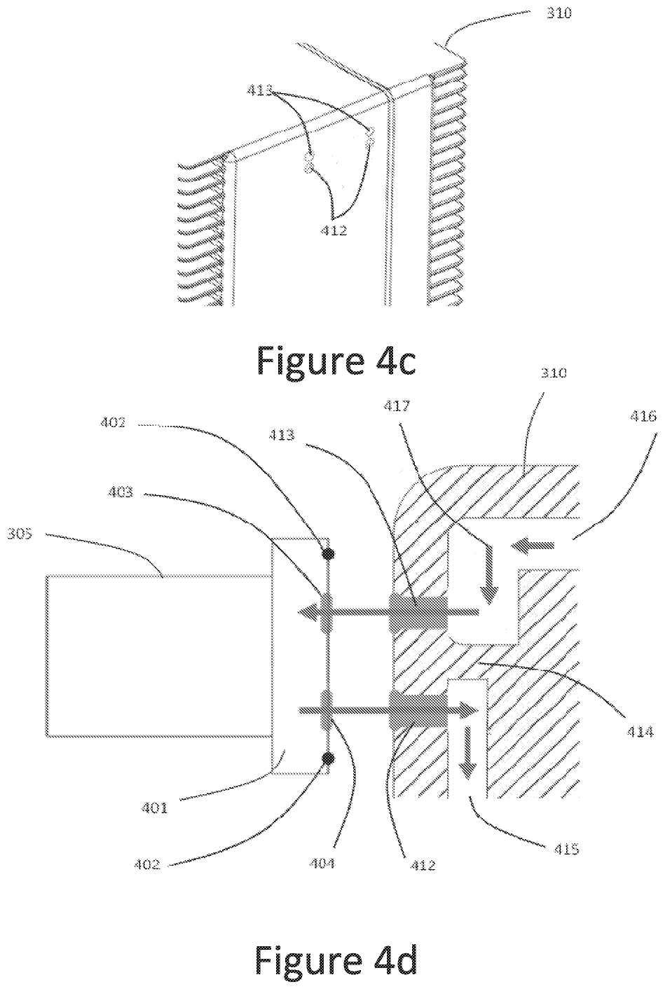

One of the pumps 305 is shown in more detail in FIG. 4a. The pump 305 is a small pump which comprises a manifold 401 having a flat interface surface. The manifold provides a means by which the pump can be mounted directly into a flat surface of the housing. This removes extra components, such as tubing or clamps, which may be required for pumps not directly mounted to the housing. The manifold has a sealed interface with the housing 310 to prevent leaking. The sealed interface is provided with a seal 402 provided on the flat surface of the manifold, which is located between the manifold and the housing 310 when the pump is installed. The pump comprises an inlet 403, through which liquid can enter the pump, and an outlet, through which a liquid can be ejected from the pump.

The pump 305 is typically a centrifugal pump. A sectional view of an example of a suitable pump is shown in FIG. 4b. An impeller 406 is located within the body 405 of the pump 305 and is driven by a motor 407 to provide the pumping action. Liquid is drawn in through the inlet 403 through the action of the impeller 406, which then ejects the coolant liquid towards and then out of the outlet 404. Other pump arrangements may also be used that provide an inlet and outlet in the same surface. The liquid flow 417 through the pump 305 is indicated by the arrows in the figure.

A region of the housing 310 is shown in FIG. 4c, providing further detail with regards to an installation location of the pump (in this case two pumps). An inlet hole 412 and an outlet hole 412 are provided in a flat surface of the wall of the housing 310. The inlet hole 412 corresponds to the outlet 404 of the pump. The outlet hole 413 corresponds to the inlet 403 of the pump.

The installation of the pump is shown in a blown apart and partially sectional view in FIG. 4d. The inlet hole 412 and outlet hole 413 of the housing wall are separated by the internal construction 414 and walls of the housing 310. This separation allows for the circulation of liquid coolant within the housing, as the inlet and outlet are physically separated, the liquid coolant is prevented from simply circulating proximal to the pump. Instead the coolant flow 417 is directed from the inlet hole 412 in the housing wall to further internal cooling channels through a first interface 415, until it returns to the outlet hole 413 in the housing wall via a second interface 416.

In this way the pump can be surface mounted directly onto the surface of the housing. This provides a single sealed interface which in turn avoids the need for any tubes/fittings reducing part count, assembly costs and the risk of a leakage. The battery pack uses the housing's internal construction in order to keep the inlet and outlet flows separated and direct these flows to internal cooling channels within the housing.

Various means for mounting the pump 305 to the housing can be used. For example, the pump manifold can be welded to the housing and/or a threaded hole or recess can be provided in the housing to correspond to a bolt associated with the pump. Any means that ensure a sealed fit between the housing 310 and the pump 305 may be used.

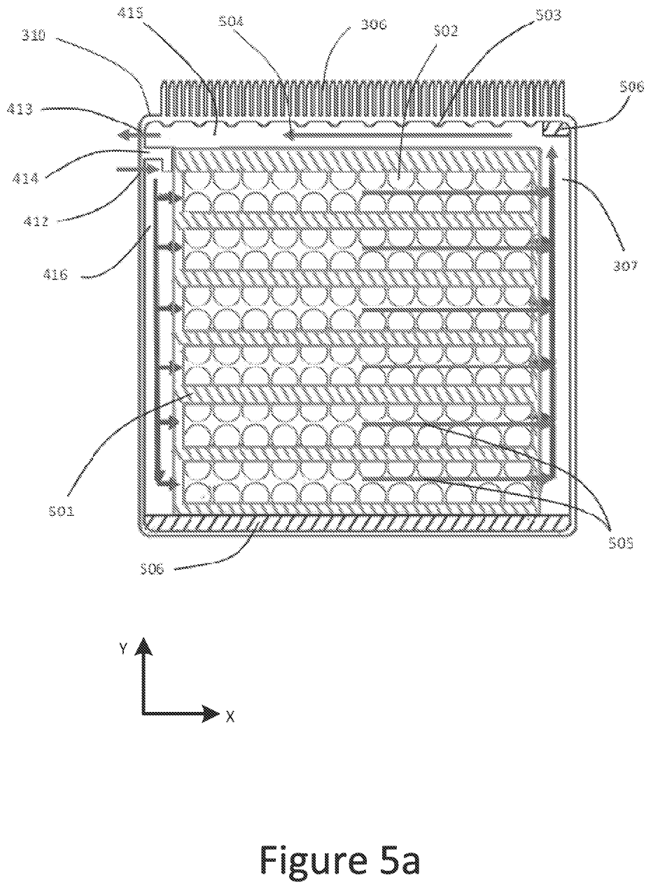

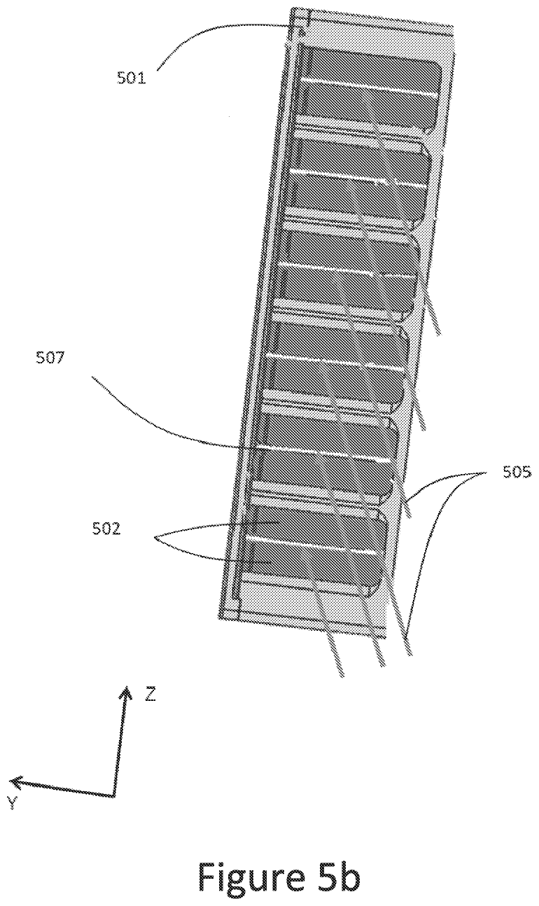

A cross sectional view of a configuration of the battery pack 300 providing a view from inside the housing 310 is provided in FIG. 5a. The plurality of cells 502 are arranged in a grid pattern and held in place by a scaffolding 501. The scaffolding 501 is plastic for ease of construction and lightness, other suitable materials may also be used. The scaffolding itself has holes for the coolant liquid to enter and leave through. The combined arrangement of the scaffolding and cells also defines channels through which the coolant can flow past the surface of the cells 502 along the flow paths 505. Finally, the scaffolding provides a means of attachment and holding for the busbars (not shown) which are in electrical contact with the cells 502. Using the scaffolding 501 for these multiple purposes reduces the part count and therefore the complexity and costs of producing the battery pack 300.

The housing 310 and scaffolding 501 together also create internal channels and flow paths 504 for the liquid coolant to flow through on the inside of the housing. The channels created internally by the arrangement and construction of the housing 310, the scaffolding 501 and the cells 502, direct liquid across the cells to take up heat from cells, and then around the internal surface of the housing. Heat is therefore transferred from the cells to the liquid coolant, from the coolant to the walls of the housing, and from the housing to the external/ambient environment.

The internal construction 414 of the housing that separates the inlet 412 from the outlet 413 abuts the scaffolding to further define the flow channels 416, 417. The internal construction 414 may comprise a fitting and/or locating means that corresponds to a fitting and/or locating means on the scaffolding. The scaffolding is fitted to the housing to define the channels and to space and/or locate the cells within the housing.

Ribs 503 (or other protrusions) are provided on the inside of the housing. These increase the surface area of the internal walls of the housing, which in turn increases the rate of heat transfer from the coolant to the housing. Similarly, fins 306 or other suitable protrusions such as vanes or ribs increase the surface area on the outside surface of the housing and therefore increase the transfer of heat from the housing to the external environment.

The construction of the housing and scaffolding is arranged to reduce the volume of coolant required whilst still providing adequate heat exchange. The pathways formed by the negative space defined by the arrangement of the housing and scaffolding (and the cells themselves) are therefore narrow. Where larger voids or pockets are formed due to construction techniques (or otherwise) then the scaffolding may be arranged to fill those voids. In this and other configurations foam blocks 506, or other suitable filling material, is provided and affixed to reduce the empty volume within the housing. The space filling material (in this case foam) is selected based on its lightweight properties. Low density materials are therefore preferred for this purpose.

For example, the housing 310 when empty may have a volume of about 30 litres. The battery cells may have a combined volume of about 10 litres. The remaining space for coolant liquid would therefore be about 20 litres. However, the scaffolding 501 has a volume also. The volume of the scaffolding to perform its battery cell mounting, positioning and locating function can be quite low, but we may choose to have it deliberately have a bigger volume when defining not only the direction and existence of coolant liquid flow paths but also their cross section (in combination with the housing and the battery cells so as to achieve a desired volume of coolant adjacent the battery cells and housing without having too much liquid present. For example, the scaffolding might have a volume of 13 litres, which means that instead of about 20 litres volume of liquid we have 7 litres volume of liquid. We have realised that we can get good performance whilst at the same time reducing the volume of (expensive) coolant liquid that is needed, up to a certain point anyway—i.e. avoiding “excess” liquid in the places where it is not needed.

The arrangement of the cells 502 within the scaffolding 501 is shown in more detail in FIG. 5B. The view is such that the cells are viewed side on rather than end on as in the previous figures in order to show the gaps 507 formed between the cells through their spacing by the scaffolding 501. The gaps 507 between the cells provide flow paths 505 for the coolant which flows through the channels formed by the scaffolding. The scaffolding itself can have holes or apertures to allow coolant liquid to flow through it.

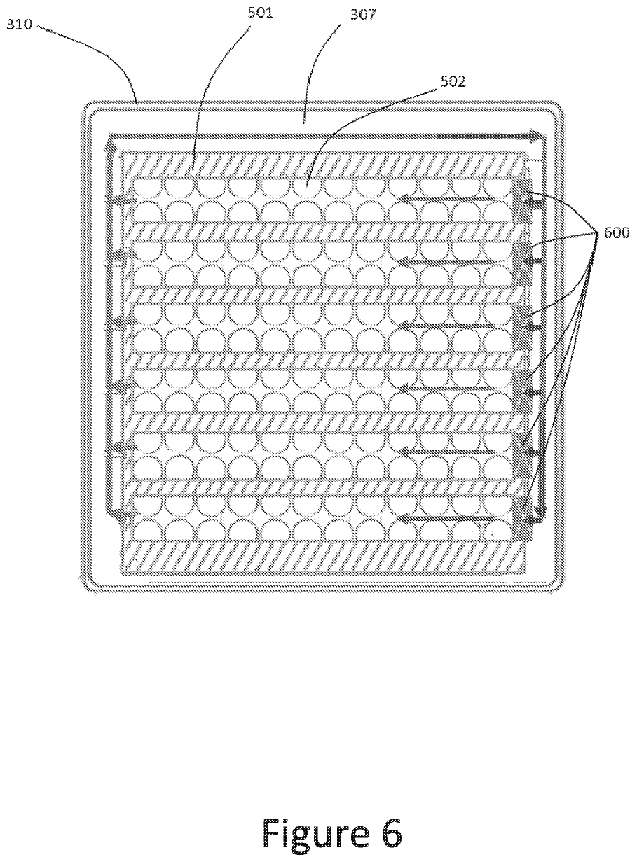

A cross sectional view of another configuration of the battery pack is shown in FIG. 6. In this configuration the surface mounted pumps have been replaced by internally located impellers or pumps 600, situated inside the housing 310. Using internal pumps or impellers 600 reduces the number of holes required in the housing, thereby reducing the probability of leaks compared to mounting pumps externally. The internal pumps or impellers 600 are mounted using the scaffolding 501. The internal pumps or impellers 600 are arranged to direct coolant 307 down flow paths 505 provided by channels formed between the cells 502 and the scaffolding 501 and in a cooling loop within the housing 310. Of course, the internal pumps or impellers could be replaced by external pumps, for example in the same locations on the housing.

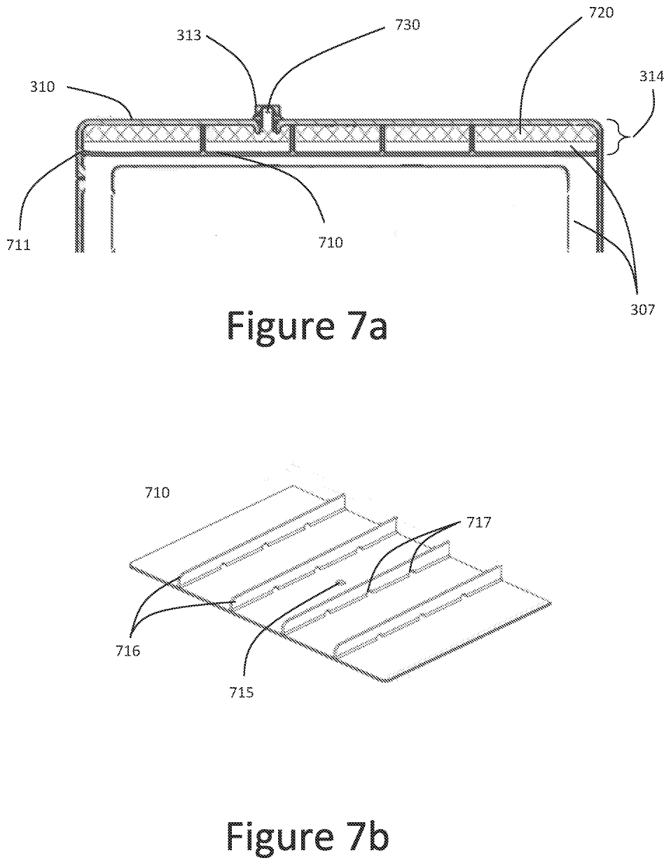

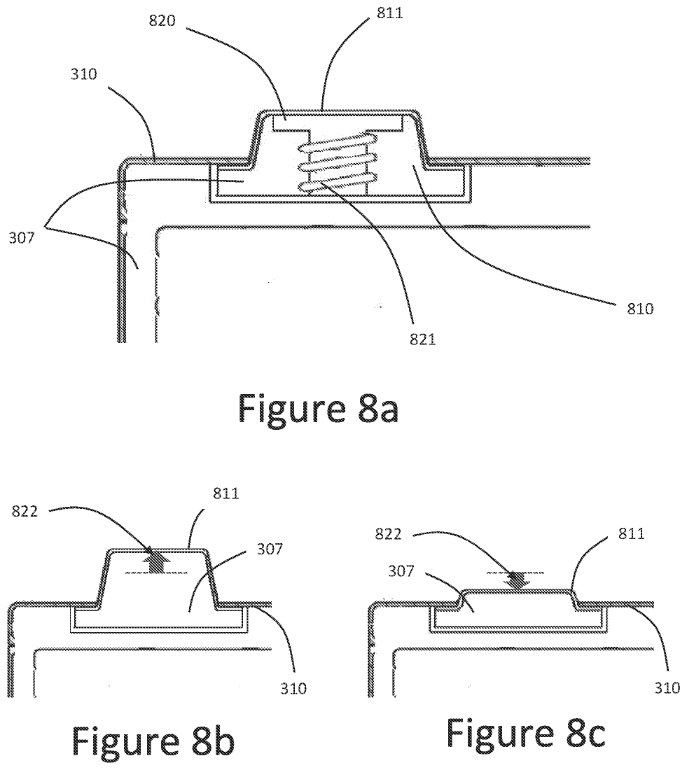

As the temperature within the battery pack fluctuates the pressure also changes. Arrangements to accommodate for these changes in pressure are shown in FIGS. 7a, 7b, 8a, 8b, and 8c.

FIG. 7a shows an arrangement of the battery pack 300 in which it comprises a reservoir 314 configured to manage expansion and/or contraction of the coolant. The reservoir 314 is provided internally to the housing 310 at its top end and separated from the main body of the housing 310 by a divider 710. The internal walls of the housing comprise retaining means 711 for holding the divider in position to create the reservoir. The retaining means in this example are slots in which the divider can be slidably inserted into. The reservoir contains an air pocket 720 and coolant 307. The coolant is free to flow between the main housing 310 and the reservoir 705, whereas the air is prevented (in the vast majority of cases) from accessing the main body of the housing from the reservoir 314. A pressure release valve is provided on a top surface of the reservoir. The top surface of the reservoir and the top surface of the housing are one and the same; the pressure relief valve is therefore the highest point of the battery pack when the battery pack is in-use, with the reservoir being the highest point of the housing 310. This ensures that air (which has a lower density than the coolant) is kept within the reservoir as it rises to the top of the housing. The pressure release valve comprises a semi-permeable membrane 730 which allows the passage of air to and from the reservoir to and from an external environment, but prevents the passage of coolant liquid. When the coolant liquid expands due to an increase in the temperature of the battery cells, air is forced out of the reservoir through the pressure release valve 313, helping to maintain the internal pressure. As the battery pack cools and the coolant liquid contracts, air is drawn back into the reservoir through the pressure release valve 313.

The divider 710 is shown by itself in FIG. 7b. The divider comprises a hole 715 (which may be provided as multiple holes, a mesh or similar in other configurations) to allow the passage of the coolant from the reservoir to the main housing and vice versa. The hole 715 is arranged such that air from the air pocket is unlikely to be able to flow into the housing from the reservoir. As the hole is centrally located in the divider it would take extreme tilt angles (approaching 90°) before air would be able to pass into the housing. Walls 716 with small apertures 717 are provided in the reservoir to restrict the movement and reduce the sloshing of the coolant liquid in the reservoir when the battery pack experiences acceleration and/or tilting.

Angles that may allow air to pass from the reservoir into the main housing body are extremely unlikely to be reached in most uses of a battery pack, such as in a vehicle, for example a motorbike or scooter. Because such angles are not reached, air is prevented from entering the housing and therefore kept away from the coolant liquid channels and the pumps. Air may also reduce the operating efficiency of the coolant as it may act as an insulator. The pressure relief valve 308 is provided at the top of the reservoir 314. In this way only air, and not the coolant, is expelled in high pressure (due to high temperature) events. In certain arrangements (for example where the battery is used for building energy storage) the reservoir can be implemented without a divider. The divider militates against tilt events. A stationary battery pack 300 should not tilt and so a divider may not be implemented. The configuration of the reservoir and divider is therefore dependent on the use case for the battery pack 300, and in particular the variation of the orientation of the battery pack 300 and any acceleration forces it may be subjected to in use.

In another configuration the reservoir may instead be provided as a separate component and connected via a tube to the housing.

In other arrangements no air pocket is provided and coolant expansion and/or contraction is managed through the use of a diaphragm 811 or bellow. FIGS. 8a, 8b, and 8c provide an example of such a system. The diaphragm 811 is fitted into a cut-out of the housing 310 and robustly sealed to prevent leakage. A piston 820 and spring 821 assembly is provided and connected to the diaphragm in order to maintain internal pressure. As the coolant expands when its temperature increases the diaphragm can stretch to accommodate the extra volume, bulging outwards. The diaphragm is formed from a flexible, non-reactive material such as rubber or any suitable synthetic or composite material operable to elastically flex in order to provide a dynamic volume, fitted onto the spring-loaded piston 820, 821. During expansion, as shown in FIG. 8b, the diaphragm stretches allowing for an increase in the effective housing volume. During contraction, as shown in FIG. 8c it relaxes allowing for reduction in the effective housing volume. The diaphragm's material, the spring's stiffness and the overall assembly's structural design is configured to provide adequate expansion and contraction during respective high and low pressure events (such that liquid flow inside the housing is not adversely affected at low temperatures and such that that there is no chance of leakage at high temperatures).

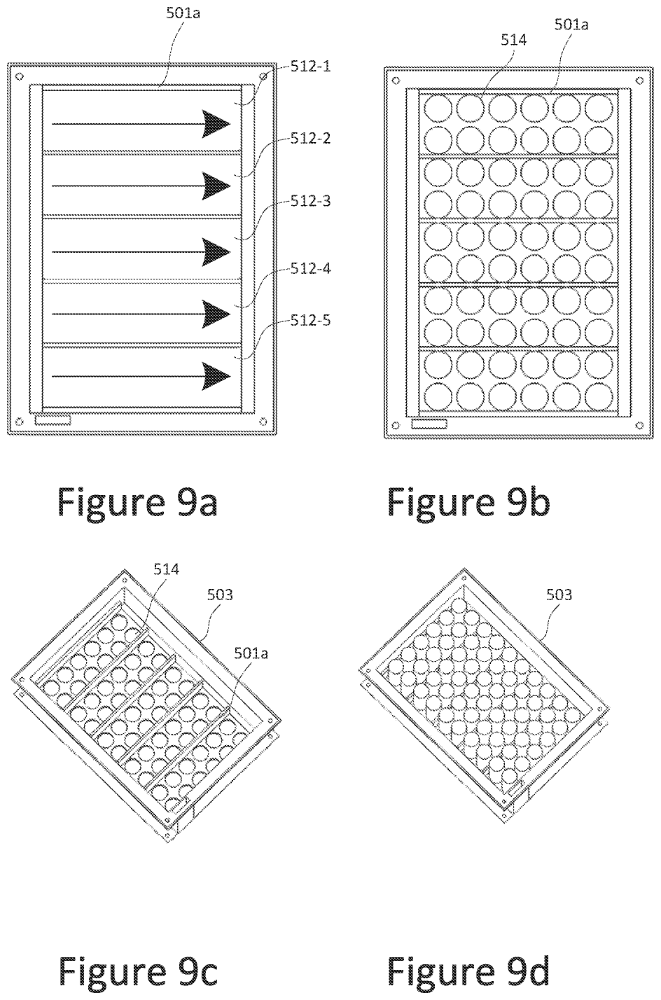

Referring to FIG. 9a, an embodiment of a lower part of the scaffolding 501a is shown in a plan view. In this embodiment, the lower part of the scaffolding comprises dividers that define separate scaffolding channels 512-1 . . . 512-5 in the battery pack. As shown in FIG. 9b, the lower part of the scaffolding, and in particular the channels of the lower part, may further comprise cell receptacles 514 in which the battery cells can be placed. The use of such a scaffolding simplifies the manufacturing of the battery pack and ensures correct placement of the battery cells.

FIGS. 9c and 9d show the lower part of the scaffolding 501a from a perspective view before and after the battery cells are located in the cell receptacles 514.

Exemplary flows across the channels 512-1 . . . 512-5 of the scaffolding are shown in FIG. 9a. As shown in this figure, typically the battery pack is arranged so that the direction of flow in each of the channels is the same, from a first side of the battery pack to a second side of the battery pack. A battery pack that provides such unidirectional flow is described below. Having the same direction of flow in each channel enables the provision of various sizes of battery packs via the use of differing numbers of scaffolding layers, while providing more uniform cooling and increased performance compared to a battery pack with flows of alternating directions.

In order to promote the flow of coolant through the scaffolding channels 512-1 . . . 512-5 from a first side of the battery pack to a second side of the battery pack, the battery pack is arranged so that, during use, the pressure on a first side of the scaffolding channels is greater than the pressure on the second side of the channels; therefore, there is a continuous flow of coolant through the channels in the desired direction.

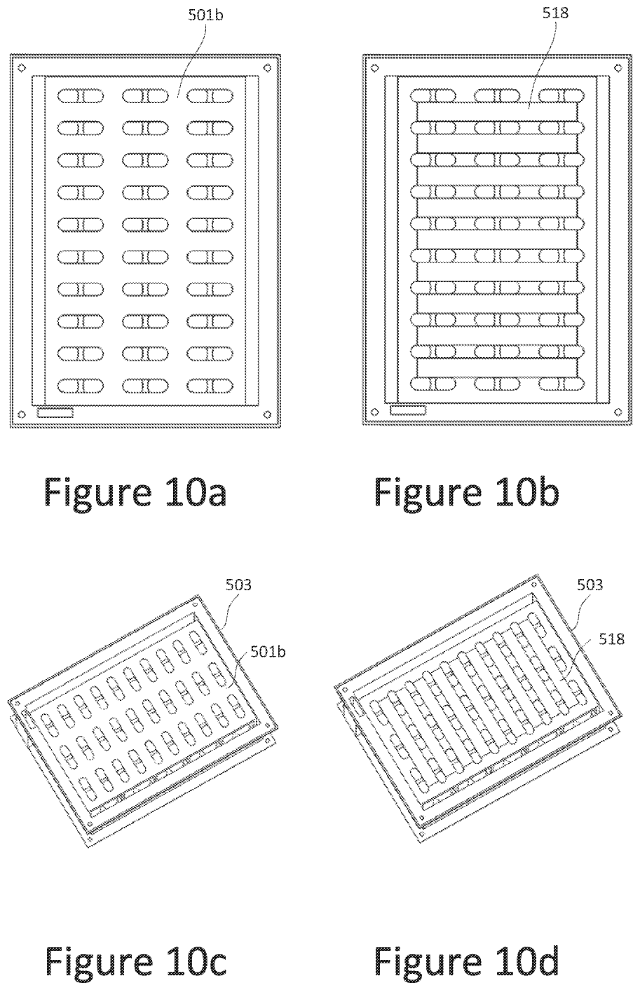

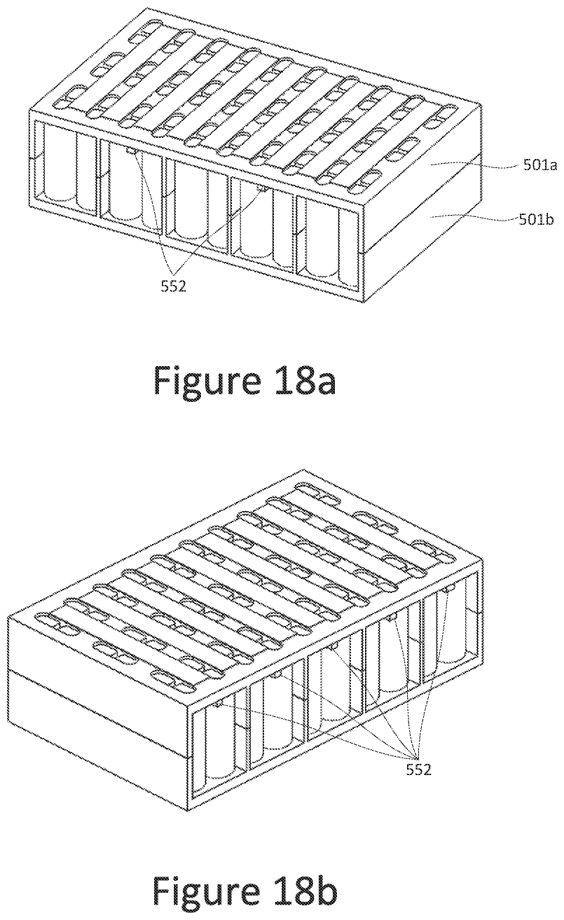

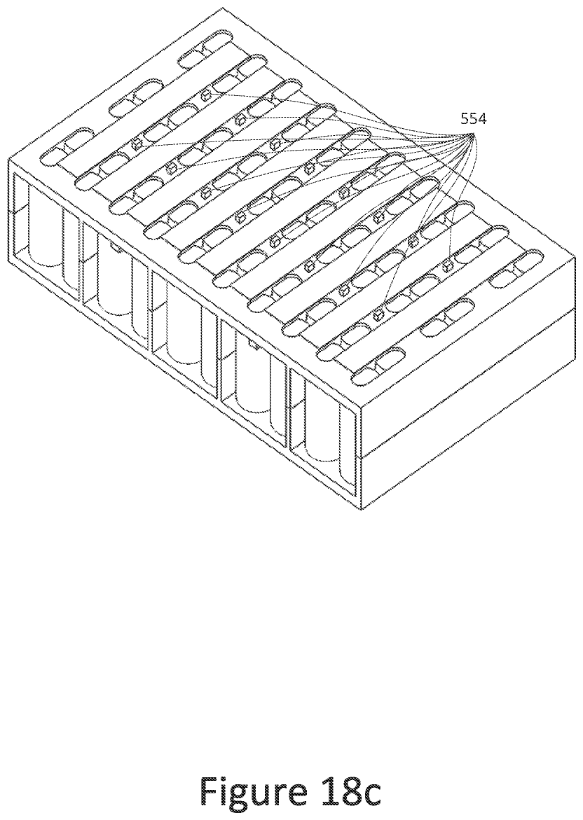

In practice, the scaffolding 501 is typically a part of a battery cell layer, where in order to manufacture the battery cell layer battery cells are lowered into the receptacles of a lower part of the scaffolding 501 a, and then after the cells have been inserted into the cell receptacles (as shown in FIG. 9d), an upper part of the scaffolding 501b is lowered onto the lower part of the scaffolding and/or the cells to secure the cells within the cell receptacles of the scaffolding. A plan view and a perspective view of the upper part of the scaffolding are shown in FIGS. 10a and 10c respectively. A composition of the scaffolding that has a lower part and an upper part is also shown in FIGS. 18a -18c.

The upper part of the scaffolding 501b typically comprises channel dividers and/or cell receptacles that align with the channel dividers and the cell receptacles of the lower part so that the lower part of the scaffolding 501a and the upper part of the scaffolding cooperate to form the channels and the cell receptacles.

Referring to FIG. 10b, once the upper part of the scaffolding 501b is in place, a busbar 518 is placed on top of this upper part of the scaffolding. The busbar comprises electrical connections in order to transfer the power generated by the battery cells to the components of the vehicle in which the battery pack is located. This busbar may then be covered with a top cover, e.g. a plastic cover. In order to enable the busbar to be connected to the battery cells, as shown in FIG. 10a the upper part of the scaffolding typically comprises cut-out sections that provide access to the terminals of the battery cells. The busbar and the top cover form a part of the battery cell layer along with the scaffolding 501 and the battery cells; therefore, each battery cell layer is capable of providing power to an external source via the battery cells and the busbar.

Each of these components may be lowered into, and then secured in, a housing segment 503 associated with the battery cell layer using a fixing means, such as screws. The process of building up the battery cell layer is shown clearly by the perspective views in FIGS. 9c, 9d, 10c, and 10d. Typically, each component (e.g. the scaffolding, the busbar, the top cover) comprises mounting holes which align when the layers are placed into the housing segment. Therefore, once each component has been placed into the housing segment, long screws can be placed through the mounting holes of each section in order to fix each layer together and thereby form a battery cell layer.

Within this battery cell layer, the battery cells in the scaffolding 501 are typically arranged so that the coolant flows transversely across the cells. This enables the battery cells and the busbar to be arranged so that the coolant does not flow between the cells and the busbar 518.

While each battery cell layer typically comprises a scaffolding for locating the battery cells and providing channels, more generally there may be provided a battery cell layer in which battery cells can be located such that coolant flows across these battery cells. Typically, each battery cell layer is associated with a top cover and a busbar, but this is not required. Typically, the battery cell layers each comprise a plurality of channels, which channels are typically part of a scaffolding (but equally the channels could be formed in another manner). Where the description refers to channels of a battery cell layers, the disclosure equally applies to channels of scaffoldings and vice versa.

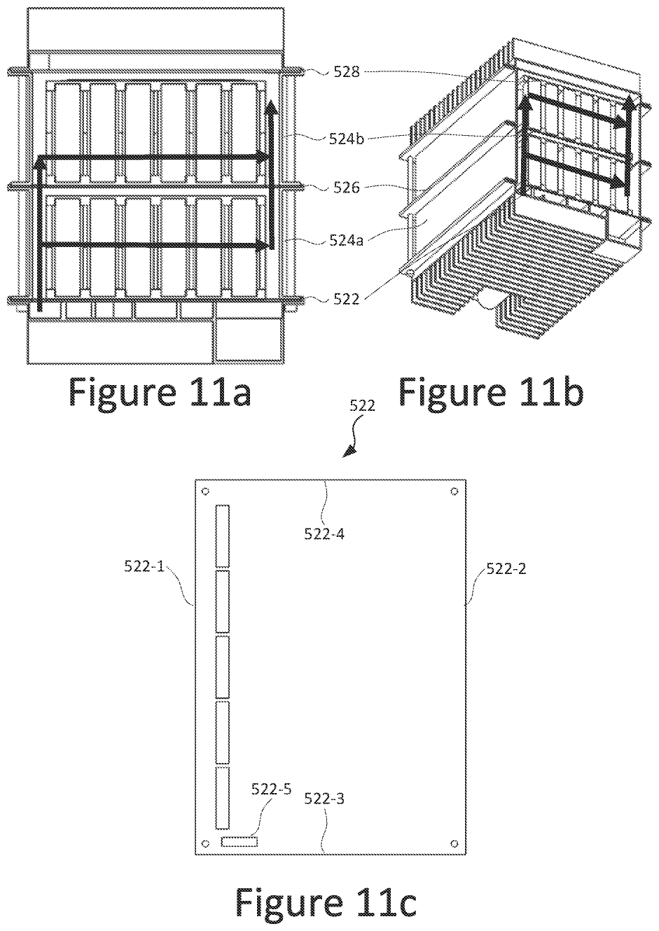

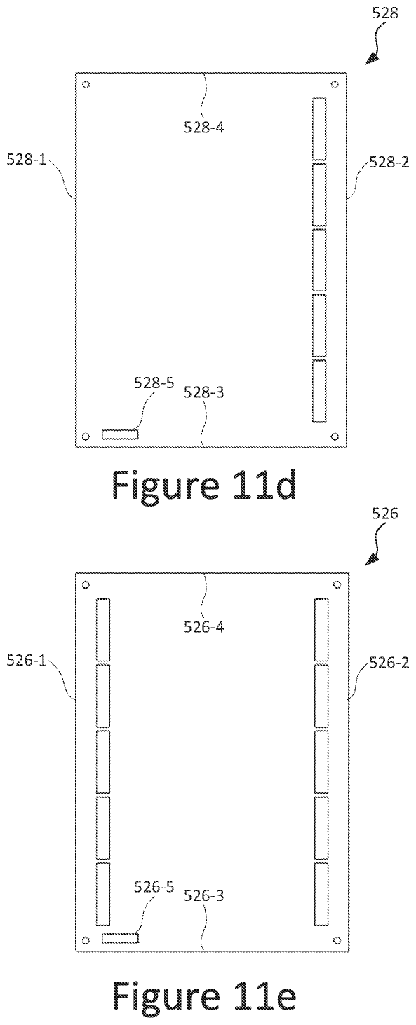

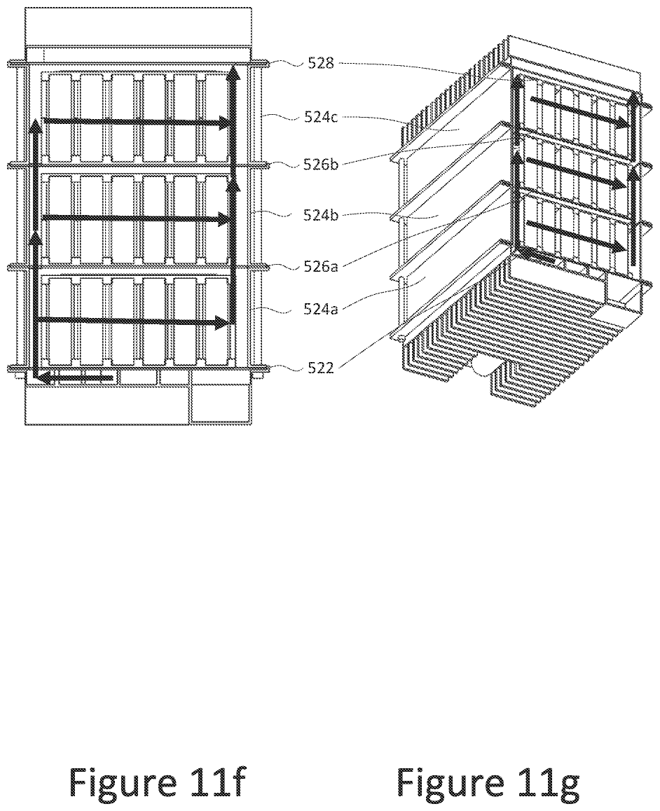

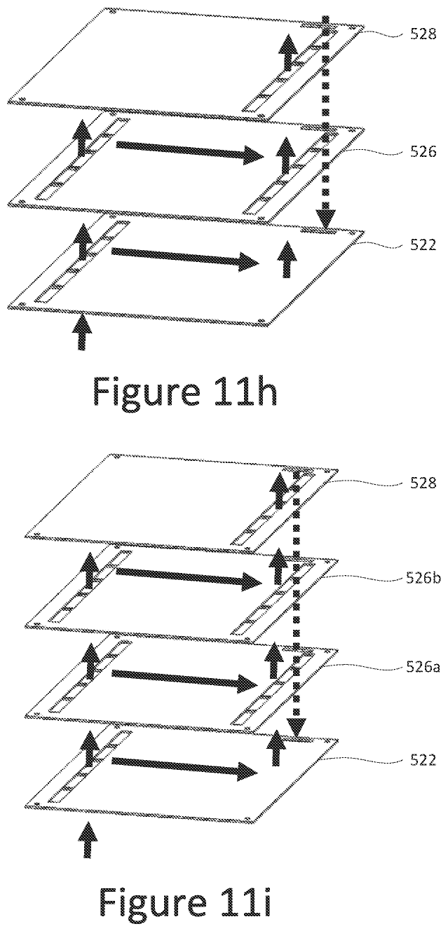

According to the present disclosure, a plurality of battery cell layers, and/or a plurality of layers of scaffolding are provided in order to form a battery pack of a desired size and capacity. A method of arranging this plurality of battery cell layers to form a battery pack is described with reference to FIGS. 11a-11i.

Specifically, the battery pack comprises a bottom gasket 522, a plurality of battery cell layers 524a, 524b that are separated by a middle gasket 526, and a top gasket 528.

Typically, each of the battery cell layers comprises a structure for locating a gasket adjacent the battery cell layer (and/or adjacent the housing segment associated with the battery cell layer). Such a structure is useable to ensure each gasket is properly positioned so that in use the gasket forms a seal between the battery cell layer and a neighbouring component (e.g. a neighbouring battery cell layer).

The bottom gasket 522 is shown in more detail in FIG. 11c, the top gasket 528 is shown in more detail in FIG. 11d, and the middle gasket 526 is shown in more detail in FIG. 11e.

The battery pack, and each gasket 522, 526, 528, has four sides, including a first side 522-1, 526-1, 528-1 and a second side 522-2, 526-2, 528-2 located on opposing sides of the gasket and a third side 522-3, 526-3, 528-3 and a fourth side 522-4, 526-4, 528-4 located on opposing sides of said gasket. The gaskets are arranged in the battery pack so that the first sides of each gasket are aligned, the second sides of each gasket are aligned, etc. As shown in FIGS. 11c-11e:

The bottom gasket 522 comprises one or more holes along the first side 522-1 of the bottom gasket (e.g. only along the first side).

The middle gasket 526 comprises one or more holes along both the first side 526-1 and the second side 526-2 of the middle gasket.

The top gasket 528 comprises one or more holes along the second side 528-2 of the top gasket (e.g. only along the second side).

Therefore, when the battery pack is assembled the one or more holes along the first side 522-1 of the bottom gasket 522 align with the one or more holes on the first side 526-1 of the middle gasket 526 and the one or more holes along the second side 528-2 of the top gasket 528 to align with the one or more holes on the second side 526-2 of the middle gasket 526.

The holes of the gaskets are arranged to correspond to the channels of the battery cell layers 524a, 524b. Specifically, each gasket comprises a number of holes that is related to and/or equal to a number of channels of the battery cell layers so that coolant is able to flow through the holes of each gasket into an associated battery cell layer channel. Therefore, where the battery cell layers (e.g. the scaffoldings in the battery cell layers) comprise five channels, the gaskets typically comprise five holes arranged so that coolant can flow through the five holes into these five channels.

Each battery cell layer is arranged in the battery pack such that the channels of the battery cell layers 524a, 524b provide a flow path between the first sides of the gaskets 522-1, 526-1, 528-1 and the second sides of the gaskets 522-2, 526-2, 528-2. Therefore, coolant is able to flow from a first end (e.g. the bottom) of the battery pack to a second end (e.g. the top) of the battery pack via the gaskets and coolant is able to flow from a first side (e.g. the left) of the battery pack to a second side (e.g. the right) of the battery pack via the channels in the battery cell layers.

In order to allow the flow of coolant between the channels of the battery cell layers 524a, 524b and the gaskets, the busbar 518 and/or the top cover typically comprise transfer holes that align with the holes of the gaskets in use. The transfer holes are typically arranged along both a first side and a second side of the top plate and the busbar to provide compatibility with each type of gasket. Equally, the top plate and/or the busbar may be sized so that coolant can flow around the top plate and/or the busbar. In this regard, in some embodiments instead of holes the busbar and the top cover comprise cut-outs that enable coolant to flow past these components (e.g. semi-circular cut-outs at the sides of the busbar/top cover).

It will be appreciated that the battery pack may not have a quadrilateral cross-section, so while FIGS. 11c-11e show rectangular gaskets, other shapes may be used for the gaskets. More generally, each of the bottom gasket 522 and the top gasket 528 have arrangements of holes along opposing sides of the bottom/top gasket and the middle gasket 526 has arrangements of holes along both sides of the middle gasket. Therefore, coolant that enters a first side of a battery cell layer via holes of the bottom gasket is able to exit a second side of a battery cell layer via the holes of the top gasket.

In some embodiments, only one battery cell layer is provided and no middle gasket is provided. Therefore, coolant is able to: flow through the holes in the first side of the bottom gasket 522; then flow through the channels of the battery cell layer to the second side of the gaskets; and then flow through the holes in the second side of the top gasket 528.

Where multiple battery cell layers and one or more middle gaskets are provided, the flows of the coolant are as shown in FIG. 11a. Specifically, the coolant first flows through the holes in the first side 522-1 of the bottom gasket 522. A first portion of this coolant then flows: through the channels of the first battery cell layer 524a towards the second side of the battery; through the holes in the second side 526-2 of the middle gasket 526; and then through the holes in the second side 528-2 of the top gasket 528. A second portion of this coolant flows: through the holes in the first side 526-1 of the middle gasket; then through the channels of the second battery cell layer 524b; and then through the holes in the second side 528-2 of the top gasket 528.

With this arrangement, where flow moves from a first end of the battery pack to a second end of the battery pack, and from the first side of the battery pack to the second side of the battery pack, a plurality of battery cell layers may be provided while maintaining consistent cooling of the battery cells located therein (and avoiding hot-spots). To avoid back-flows and achieve a consistent flow, the pressure at the entrance of each channel at the first side of the battery pack is arranged to be higher than the pressure at the exit of that channel at the second side of the battery pack. This is achieved using the pump 305.

As shown in FIGS. 11c-11e, typically each gasket 522, 526, 528 comprises a fluid return hole 522-5, 526-5, 528-5 on the third side 522-3, 526-3, 528-3 or the fourth side 522-4, 526-4, 528-4 of that gasket. The fluid return holes combine to provide a passage through which the coolant can flow from the top of the battery pack to the bottom of the battery pack (to achieve a loop of coolant). The battery cell layers 524a, 524b and/or an enclosure of the battery pack may each comprise a corresponding fluid return channel so that the coolant can flow between the fluid return holes of the gasket and the fluid return channels of the battery cell layers/an enclosure.

In some embodiments, one or more of the gaskets 522, 526, 528 is sized so that the passage for fluid return is outside of the corresponding battery cell layers. Such gaskets may be provided without a fluid return hole.

As can be seen in FIGS. 11a and 11b, the direction of flow through each hole on the first side 522-1, 526-1, 528-1 of the gaskets and the second sides of the gaskets is the same 522-2, 526-2, 528-2; specifically, the coolant flows through these holes of the gaskets from the first end (e.g. the bottom) of the battery pack to the second end (e.g. the top) of the battery pack before the entirety of the coolant is returned to the bottom of the battery pack via the fluid return holes 522-5, 526-5, 528-5. The coolant passing from the bottom to the top in this way (as opposed to in a u-shaped flow) enables the provision of a plurality of battery cell layers while maintaining uniform temperatures throughout the battery pack.

Referring to FIGS. 11f and 11g, a battery pack of any size can be provided using this arrangement by providing a plurality of battery cell layers 524a, 524b, 524c along with a plurality of middle gaskets 526a, 526b, where each pair of battery cell layers is separated by a middle gasket. While FIGS. 11f and 11g show an arrangement with three battery cell layers, it will be appreciated that any number of battery cell layers may be provided (e.g. three layers, five layers, and/or ten layers). Where a large number of battery cell layers are provided, a powerful pump may be required to achieve an effective rate of coolant flow through each layer of scaffolding.

FIGS. 11h and 11i show more clearly the flows through the gaskets, where the coolant flows from the first end of the battery pack to the second end of the battery pack via the holes in the first and second sides 522-1, 526-1, 528-1, 522-2, 526-2, 528-2 of the gaskets 522, 526, 526a, 526b, 528 and then flows back from the second end to the first end via the return holes 522-5, 526-5, 528-5.

In order to manufacture the battery pack, the bottom gasket 522 is provided and the first battery cell layer 524a is then provided on top of the bottom gasket (where the first battery cell layer typically contains a lower part of a scaffolding, an upper part of the scaffolding, a plurality of cells, a busbar, and/or a top cover); the middle gasket 526 is then placed onto the first battery cell layer, and the second battery cell layer 524b is placed on top of the middle gasket. This process of placing battery cell layers and middle gaskets may be repeated with a plurality of battery cell layers, with each battery cell layer being separated by a middle gasket. The top gasket 528 is then placed on top of an uppermost battery cell layer. This method provides a straightforward way of manufacturing batteries of different sizes.

Each battery cell layer is typically associated with a separate housing segment, where these housing segments cooperate to form an outer housing (or an ‘enclosure’) of the battery pack. Equally, there may be provided a separate enclosure, where each of the battery cell layers and the gaskets are placed into this enclosure.

‘Placing’ the components of the battery pack typically comprises lowering the components onto each other. This enables a straightforward method of manufacturing and results in each gasket being deformed by the weight of the components on top of that gasket. This deformation of the gaskets leads to each gasket forming a seal between the components to either side of that gasket. For example, each middle gasket forms a seal between two neighbouring battery cell layers. Typically, the formation of the seals is further encouraged by inserting fastenings (e.g. screws or bolts) through holes in the housing segments and/or end plates and tightening these fixings to press the layers of the battery pack together.

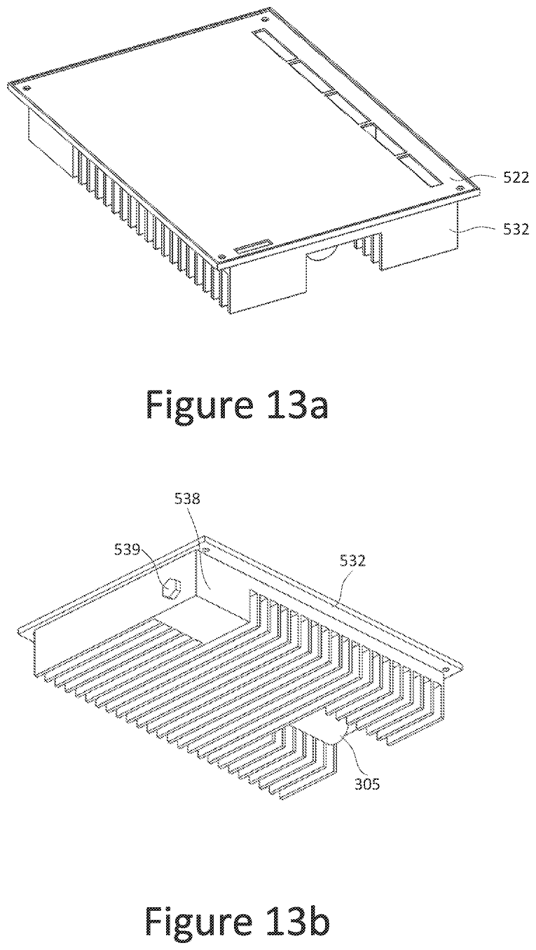

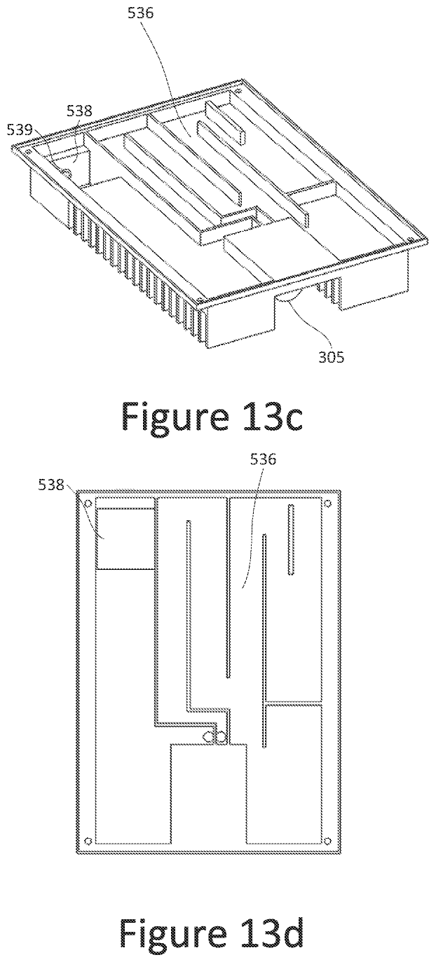

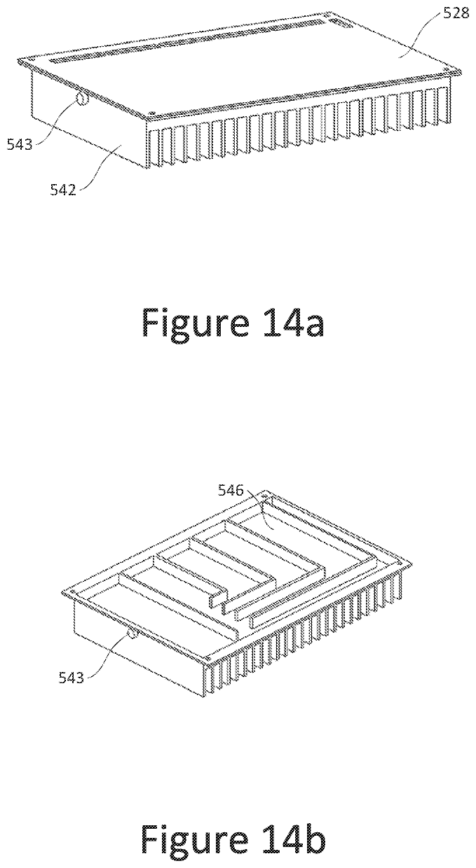

In order to secure each component in place and to complete the enclosure, a bottom end plate and a top end plate are located adjacent the bottom gasket 522 and the top gasket 528 respectively. Embodiments of these end plates are described below with reference to FIGS. 13a-13d, and 14a and 14b.

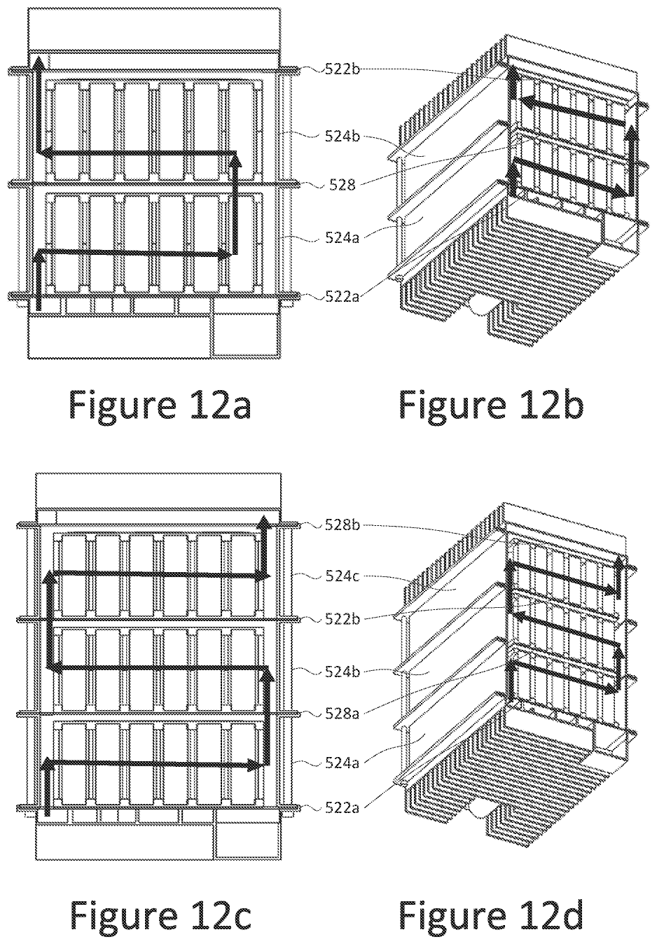

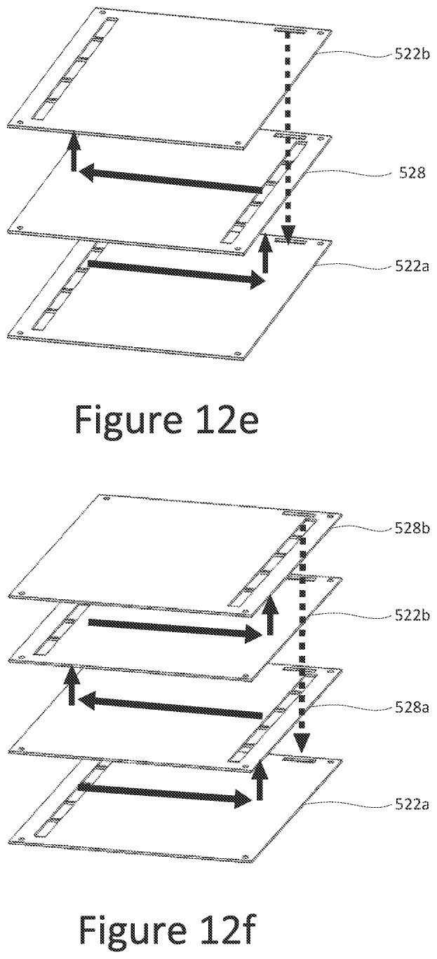

Referring to FIGS. 12-12f, where multiple battery cell layers are provided, instead of using middle gaskets, there may be provided an arrangement with alternating bottom gaskets 522a, 522b and top gaskets 528a, 528b. In particular, each battery cell layer 524a, 524b, 524c may be arranged so that a first face of that battery cell layer is adjacent a top gasket and a second face of that battery cell layer is adjacent a bottom gasket (so that where there are multiple battery cell layers, a stack is formed that comprises: a bottom gasket; a battery cell layer; a top gasket; a battery cell layer; a bottom gasket; etc.).

With such an arrangement, the entirety of the coolant flows through the channels in each battery cell layer so that the coolant moves:

1. through the holes in the first side of a first bottom gasket 522a;
2. between the first side and the second side of the battery pack via the channels in a first battery cell layer 524a;
353. through the holes in the second side of a top gasket 528;
4. between the second side and the first side of the battery pack via the channels in a second battery cell layer 524b; and
5. through the holes in the first side of a second bottom gasket 522b.

It will be appreciated that with such an arrangement, a ‘bottom’ gasket might be above a ‘top’ gasket. In practice, the battery pack comprises a plurality of gaskets, including: gaskets of a first gasket type (‘bottom’ gaskets), gaskets of a second gasket type (‘top’ gaskets), and optionally gaskets of a third gasket type (‘Middle’ gaskets).

As with the arrangement using middle gaskets, this arrangement with alternating bottom and top gaskets enables the provision of a battery pack of any size.

Typically, in such embodiments, the gaskets are arranged so that the coolant still flows from the first side of the battery pack to the second side of the battery pack, e.g. so that the lowermost gasket is a bottom gasket and the uppermost gasket is a top gasket (as shown in FIG. 12b).

This enables the use of the same endplate for battery packs using alternating arrangements of top and bottom gaskets and battery packs that use middle gaskets as described with reference to FIGS. 11a-11e.

It will be appreciated that any combination of bottom, middle, and top gaskets may be used. For example, the first top gasket 528a of FIG. 12b could be replaced with a middle gasket so that only a portion of the coolant passes through the channels of the first battery cell layer 524a. The use of varying combinations of gaskets enables the flow of coolant through a battery pack to be optimised for any situation.

Referring to FIGS. 13a-13d, an embodiment of a bottom end plate 532 is shown. Such a bottom end plate is placed adjacent to the bottom gasket 522 so that the bottom end plate forms a part of the external surface of the battery pack and so that the bottom gasket forms a seal between the bottom end plate and a neighbouring battery cell layer. The bottom end plate typically comprises a structure for locating a gasket to aid in the forming of this seal (e.g. the top end plate may comprise a recess into which a gasket can be placed).

The bottom end plate typically comprises cooling fins and/or vanes on an outer surface to improve heat transfer from the battery to a fluid (typically air or water) surrounding the battery pack.

As shown in FIGS. 13b-13d, the bottom end plate 532 typically comprises a reservoir 538 and/or a pressure release valve 539, which components are described in more detail above. The reservoir provides a volume so that as the coolant heats up and expands it can fill the reservoir (and the displaced air can then escape via a valve adjacent the reservoir). This avoids undesirable increases in pressure due to the heating of the coolant. The pressure release valve enables air to exit the battery pack via the reservoir as the coolant expands; again this avoids undesirable increases in pressure due to the heating of the coolant.

More generally, the ‘pressure release valve’ described in this document may comprise any vent that allows the passage of air through the vent. Therefore, air may escape via the vent as the coolant heats up and then air may enter via the vent as the coolant cools down. Typically, the vent is arranged to enable both the ingress and exit of air. The vent may be a breather vent that has a semi-permeable membrane that allows air through in either direction but blocks the passage of liquid in either direction.

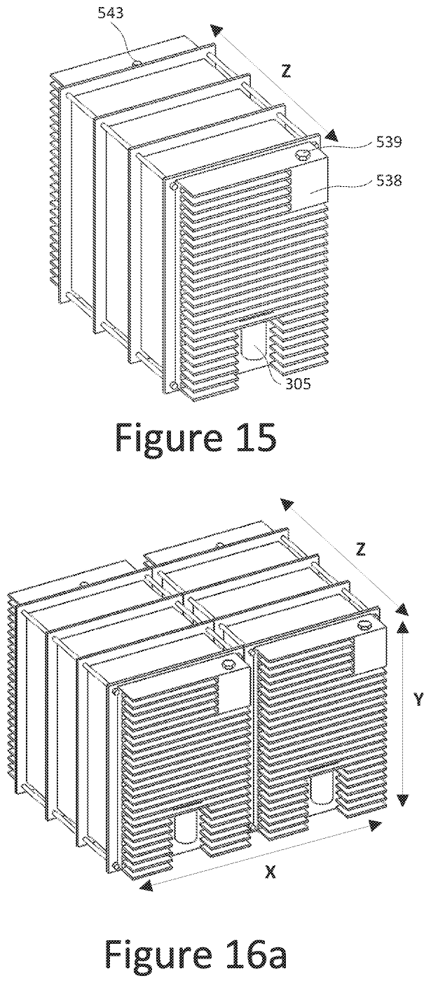

Typically, the pump 305 is integrated with, mounted on, and/or located on the bottom end plate 532 such that the coolant flows through the pump into a series of bottom end plate channels 536 in the bottom end plate. The pump may be located on the outside of the bottom end plate and/or on the inside of the bottom end plate. The pump being on the inside of the bottom end plate relates to the pump being located within the interior of the battery pack when the battery pack is assembled so that the pump is not exposed to the surroundings of the battery pack. In this regard, the bottom end plate typically forms an outer wall of the battery pack, so the pump being within the interior of the battery pack typically comprises the pump being within this outer wall. An example of an exterior mounted pump is visible in FIG. 13b and in FIGS. 15-17b, where the pump is located outside of an outer wall formed by the bottom end plate.

Arrangements of a pump that may be used with the bottom end plate, and in particular ways of mounting a pump on a surface, have been described above in more detail with reference to FIGS. 3-4d.

The bottom end plate channels 536 correspond to the channels in the battery cell layers and the holes in the bottom gasket 522 such that coolant is able to flow from the pump 305 into the bottom end plate channels and then through the holes on the first side 522-1 of the bottom gasket into the channels of a battery cell layer.

The bottom end plate channels 536 are typically each arranged in a serpentine arrangement in order to maximise the flow time required for the coolant to pass between the pump 305 and the bottom gasket 522 so as to maximise the time during which the coolant in the bottom end plate channels transfers heat to the surroundings of the battery pack via the bottom end plate 532.

Furthermore, the bottom end plate channels 536 are typically arranged so that the volumetric flow rate of the coolant passing from the pump 305 to the holes in the first side 522-1 of the bottom gasket 522 is the same for each channel of the bottom end plate channels, that is, per unit time, the same volume of coolant passes into each of the bottom end plate channels and therefore the same volume of coolant passes through each of the channels of the battery cell layers 524a, 524b (more specifically, the average volumetric flow rates are the substantially equal—and it will be appreciated that even where the average volumetric flow rates are equal there may be a small variation in the rates at any given moment). This ensures that the temperature distribution across the battery pack is substantially uniform, and thus the use of equal (or similar) volumetric flow rates reduces the likelihood of hot-spots in the battery pack. The equal volumetric flow rates are typically achieved by arranging the bottom end plate channels such that the pressure drop across each channel (e.g. between the pump and the holes on the first side of the bottom gasket) is the same.

The reservoir 538 of the bottom end plate 532 is typically located out of the flow path of the coolant (e.g. not in line with the bottom end plate channels 536). Therefore, coolant only flows into the reservoir once the battery cells, and thus the coolant, begins to heat up (where the coolant expands due to this heating). The reservoir may contain a raised step to ensure that the coolant does not flow into the reservoir when the coolant is at a low temperature.

Referring to FIGS. 14a and 14b, an embodiment of a top end plate 542 is shown. Such a top end plate is placed adjacent to the top gasket 528 so that the top end plate forms a part of the external surface of the battery pack. Similar to the bottom end plate 532, the top end plate is arranged so that the top gasket forms a seal between the top end plate and a neighbouring battery cell layer. The top end plate typically comprises a structure for locating a gasket to aid in the forming of this seal (e.g. the top end plate may comprise a recess into which a gasket can be placed).

As with the bottom end plate 532, the top end plate 542 typically comprises cooling fins and/or vanes on an outer surface of the top end plate that improve heat transfer from the battery pack to a fluid (typically air or water) surrounding the battery pack.

The top end plate 542 comprises top end plate channels 546 that correspond to the channels in the battery cell layers 524-1, 524-2 such that coolant flows from the channels in a battery cell layer into the top end plate channels via the holes in the second side 528-2 of the top gasket 528. The top end plate channels are arranged such that the coolant then flows from these top end plate channels into the pump 305 via the fluid return holes 522-5, 526-5, 528-5 in each gasket and the fluid return channels of the battery cell layers and/or enclosure (and the coolant then flows from the pump into the bottom end plate channels 536).

In some embodiments, there is provided a reversibly sealable hole 543 on the top end plate 542 that aids the insertion of coolant into the battery pack and/or the removal of coolant from the battery pack. The reversibly sealable hole is arranged to be sealed during normal operation of the battery pack. More generally, there may be provided two holes on the battery, where one of these holes may be the vent 539 and one of these holes is the reversibly sealable hole 543.

The use of the reversibly sealable hole 543 enables coolant to be inserted into the battery pack in a straightforward manner. In particular, the battery pack can be oriented so that the reversibly sealable hole is at the top of the battery pack and then coolant can be inserted into the reversibly sealable hole. The air displaced by this coolant is able to escape through the vent 539. Once the coolant has been inserted into the battery pack, the reversibly sealed hole is sealed to prevent coolant from escaping out of this hole.

The provision of two holes thus enables the battery pack to be easily filled after assembly of the battery pack. This enables the battery pack to be assembled at a factory and then filled at another location, which may reduce the transportation costs and/or the difficulty of transporting the battery pack.

In order to remove the coolant (e.g. in order to recycle or repurpose the battery pack as described further below), the reversibly sealable hole 543 is unsealed and a gas (such as air) is pumped into either the reversibly sealable hole or the second hole (e.g. the vent 539). The air pushes the coolant out of the battery pack.

Typically, the air is pumped into the vent 539 and so the coolant flows out of the reversibly sealable hole 543. As described previously, the vent is typically a semi-permeable vent that permits the passage of air but prevents the passage of coolant. By pumping air into the vent and collecting coolant from the reversibly sealable hole, no coolant flows through the vent and so no alterations are required to the vent. Therefore, removing coolant from the battery simply involves unsealing the reversibly sealable hole, pumping air into the vent, and then re-sealing the reversibly sealable hole.

Typically, before air is pumped into the battery pack the battery pack is oriented so that the vent 539 is at the top of the battery pack; therefore coolant is also encouraged to flow out of the reversibly sealable hole 543 by gravity.

To ensure the removal of all coolant, the coolant may be sucked out of the reversibly sealable hole using a suction pump.

Furthermore, to ensure that all of the coolant can be removed from the battery pack, the reversibly sealable hole 543 is typically arranged to be level with, or below, the level of the top end plate channels 546. In particular, the reversibly sealable hole is arranged so that the reversibly sealable hole is below the lowest level of the coolant in the top end plate when the battery is oriented so that the top end plate is at the bottom of the battery.

The battery pack may comprise a sealing structure for sealing the reversibly sealable hole 543, for example the battery pack may comprise a seal that can be rotated between a first position where the hole is covered and a second position where the hole is uncovered. Equally, a separate sealing structure may be used to seal the reversibly sealable hole, such as a removable plug.

While the reversibly sealable hole 543 is described here as being on the top end plate 542, more generally there are provided two holes on the battery pack, where one of these holes is typically reversibly sealable. Providing the holes on opposing ends of the battery pack (e.g. on opposing end plates) ensures that the insertion of air into the battery pack pushes coolant out of the battery (whereas the use of two nearby holes might result in the air simply flowing in and out of the battery by flowing directly between the holes).

With the components described above, and using the arrangement of FIGS. 11a and 11b to give an example, the coolant flows in a loop through the battery pack: from the pump 305 into the bottom end plate channels 536, then into the first battery cell layer 524a via the holes on the first side 522-1 of the bottom gasket 522, then either: through the channels of the first battery cell layer and through the holes on the second side 526-2 of the middle gasket 526; or through the holes on the first side of middle gasket and through the channels of the second battery cell layer 524b, then through the holes in the second side 528-2 of the top gasket 528 into the top end plate channels 546, then through the fluid return holes 522-5, 526-5, 528-5 in the gaskets and back into the pump.

As with the bottom end plate channels 536, the top end plate channels 546 are typically arranged in a serpentine arrangement and are typically arranged so that the volumetric flow rate of the coolant in each of the top end plate channels is substantially the same for each top end plate channel. This ensures that, per unit time, the same amount of coolant passes through each of the channels so that the temperature distribution across the battery pack is substantially uniform (e.g. the use of the similar flow times reduces the likelihood of hot-spots in the battery pack).

Using the described arrangement, a single bottom end plate 532 (which comprises a pump and a reservoir) and bottom gasket 522, and a single top end plate 542 and top gasket 528 can be combined with a plurality of battery cell layers 524a, 524b, 524n and middle gaskets 526 to provide a battery pack of any size.

When assembled, the bottom gasket 522 forms a seal between the bottom end plate 532 and a lower battery cell layer and the top gasket 528 forms a seal between the top end plate 542 and an upper battery cell layer. Each pair of battery cell layers is then sealed using either a middle gasket, as described with reference to FIGS. 11a-11i, or a top or bottom gasket, as described with reference to FIGS. 12a-12d.

In this way, a small battery pack (e.g. containing a single battery cell layer and no middle gaskets) and a large battery pack (e.g. containing five battery cell layers and four middle gaskets) can be manufactured on the same assembly line, with the large battery pack simply being cycled through a battery cell layer/middle gasket inserting apparatus a plurality of times, where each cycle involves a middle gasket being lowered onto a battery cell layer and then a further battery cell layer being lowered onto the middle gasket. The middle gasket then deforms to provide a seal between these two battery cell layers (this deformation may occur when the layers of the battery pack are secured/pressed together).

It will be appreciated that while the above description has referred to ‘top’ and ‘bottom’ gaskets and end plates, in practice the battery pack may have a different orientation so that these gaskets and end plates are located differently. More generally the battery pack comprises a first and second end plate and a first gasket type and second gasket type (and optionally, a third gasket type that relates to the middle gasket).

Indeed, referring to FIG. 15, in practice the battery pack is typically installed in a vehicle so that: the end plates 532, 542 are on the sides of the battery pack; the pump 305 (which is typically on the ‘bottom’ end plate) is at the bottom of the battery pack; and the reservoir 538 (which is also typically on the ‘bottom’ end plate) is at the top of the battery pack. The pump being located near the bottom of the battery pack is desirable since this reduces the chance of air entering the pump. The reservoir being located near the top of the battery pack is preferable since this enables gases to escape upwards from a vent located adjacent the reservoir (while the coolant remains in the reservoir due to gravity). The pump and the reservoir being located at opposing ends of the same bottom end plate provides a straightforward way to locate both the pump and the reservoir in the desired positions.

While the pump 305 and the reservoir 538 have been described as both being on the bottom end plate 532, it will be appreciated that these components may be distributed between the bottom end plate and the top end plate 542 in any arrangement (e.g. both of these components may be on the top end plate, or the reservoir may be on the bottom end plate while the pump is on the top end plate).

The end plates 532, 542 of the battery pack typically comprise fins and/or vanes, which vanes increase the heart transfer between the end plates and the external surroundings. The sides of the battery packs typically do not have vanes and are arranged to present a flat surface. This enables battery packs to be placed side by side to form a battery arrangement.

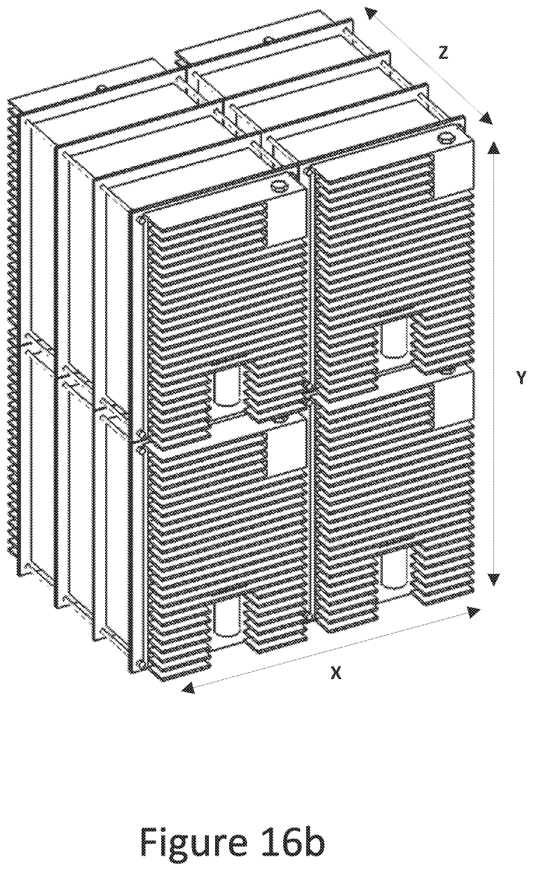

Referring to FIGS. 16a and 16b, a battery arrangement may be formed by placing a plurality of battery packs adjacent to each other. This provides a battery arrangement with a high combined capacity. The vanes of the end plates 532, 542 are typically arranged to align so that a fluid can flow along the entirety of the battery arrangement. Each battery pack of the battery arrangement typically comprises a separate coolant system, with a separate pump and/or reservoir and a separate coolant supply. The plurality of battery packs may be secured together, for example using screws, bolts and/or magnets.

While FIG. 16a shows two batteries in a side-by-side arrangement, it will be appreciated that battery packs may also be stacked on top of each other so that a 2D arrangement of battery packs is achieved (with the third dimension being associated with a number of battery cell layers present in each battery pack). In such an arrangement, the battery packs may be arranged so that the vanes of the end plates of each battery pack are parallel.

Referring to FIGS. 15, 16a and 16b, the size of each battery pack in the z-direction is determined by the number of battery cell layers used in each battery; and the size of the battery arrangement in the x-direction and the y-direction is dependent on the number of battery packs placed next to each other.

A plurality of battery packs may be placed adjacent each other with respect to the z-direction; however, such an arrangement typically reduces the heat transfer from one of the end plates of each battery pack (since the end plates of two battery packs will be near to each other). Therefore, where a plurality of battery packs are placed next to each other in the z-direction these battery packs are typically separated by at least 1 m, at least 500 mm, at least 250 mm, and/or at least 50 mm (depending on the system in which the battery arrangement is being implemented).

Where a plurality of battery packs is provided so as to form a battery arrangement, these battery packs may be connected to each other using an electrical connector. The electrical connector is typically connected to the busbars of a plurality of battery packs and therefore the electrical connector can be used to control the operation of this plurality of battery packs from a single location, e.g. to turn on or off any one of the battery packs. The electrical connector may also be arranged to provide information about the battery packs in the battery arrangement (e.g. to provide measurements from temperature sensors within these battery packs).

As shown in FIGS. 15 to 17b, the battery packs may be placed in a plurality of orientations.

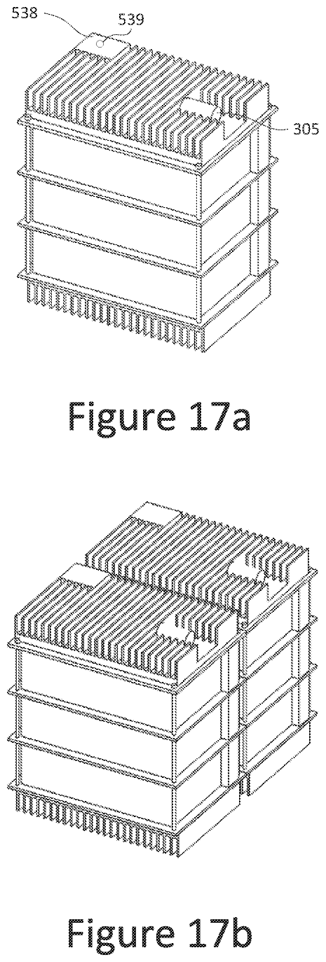

Typically, the battery packs are arranged so that the pump of each battery pack is at the bottom of that battery pack in use and/or so that the reservoir of each battery pack is at the top of that battery pack in use. Therefore, the ‘bottom’ end plate 532 of each battery pack is typically arranged to be either on a side of that battery pack (with the reservoir at the top of the bottom end plate) or on the top of that battery pack.

Where the battery arrangement is oriented such that the ‘bottom’ end plate 532 is on the side of the battery pack, the vent 539 is typically provided in the uppermost side of the bottom end plate adjacent the reservoir 538, so that air can escape upwards through the vent—this is shown in FIG. 15.

Where the battery arrangement is oriented such that the ‘bottom’ end plate 532 is on the top of the battery pack, the vent is still typically provided in the uppermost side of the bottom end plate adjacent the reservoir (so that gas can escape upwards through the vent)—this is shown in FIG. 17a. Therefore, there may be provided different bottom end plates, where the bottom end plate used for a given battery pack depends on the intended orientation of the battery pack.

Referring to FIGS. 18a and 18b, in some embodiments, the battery pack comprises temperature sensors 552 and/or pressure sensors that are associated with channels of the battery cell layers (and/or channels of the scaffoldings within the battery cell layers). In particular, each channel may be associated with one or more temperature sensors arranged to determine a temperature of the coolant in that channel. This may comprise the battery having a temperature sensor at one or more of the ends of each channel (e.g. at the entrance and/or the exit of one or more channels).

Typically, there is greater variation of temperature between the exits of the channels than between the entries of the channels. Therefore, as shown in FIGS. 18a and 18b, there may be more temperature sensors 552 provided at the exits of the channels than at the entrances so that there is a greater sensing resolution at the exits of the channels.

The temperature sensors may be used to determine a temperature distribution at the entrances and/or exits of the channels. This distribution is useable to identify a damaged cell (e.g. if one channel does not fit neatly into the distribution) and is also useable to identify trends in the heating of the cells. For example, the distribution may show that the outer channels are cooler than the inner channels, and this may result in additional coolant being diverted to the inner channels.

In some embodiments, the battery pack comprises flow rate sensors in one or more of the channels of the battery cell layers, the channels of the end plates, and the pump 305. As with the temperature sensors, flow rate sensors can be used to identify potential faults in the battery pack. In particular, flow rate sensors can be used to identify sub-optimal flow of coolant through a channel. The operation of the battery pack can then be altered accordingly (e.g. to divert more coolant through this channel).

Equally, because the bottom end plate channels 536 are arranged so that the volumetric flow rate through each channel is equal, the flow rate in each channel can be determined based on a flow rate through the pump 305.

The temperature sensors are typically arranged to measure the temperature of the coolant in each channel. By combining the temperature measurements with the determined flow rates of the channels, the temperatures in each of the battery cells can be determined. This enables the operation of the pump 305 and/or the operation of the battery cells to be altered to ensure that the temperature of each battery cell is within a desired range. In particular, if the cells are becoming undesirably hot, additional power may be provided to the pump to increase the rate of flow of coolant through the battery pack and/or less current may be drawn from the battery cells to reduce the rate of heating. The pump and/or the battery cells are typically arranged to operate in dependence on the measurements taken by the temperature sensors. This may comprise the temperature sensors providing these measurements to a control module that controls the pump and the battery cells.

The control module of the battery pack is typically arranged to determine and/or alter the operation of a battery cell or a plurality of battery cells in dependence on a combination of readings from the temperature sensors as well as current and/or voltage readings. This enables the control module to identify faulty battery cells. As described above, these faulty cells may then be deactivated. In some embodiments, cells can be individually controlled; however, typically cells are controlled in groups so that deactivating a faulty cell comprises deactivating a plurality of cells including the faulty cell (e.g. all of the cells in a channel and/or all of the cells in a battery cell layer). Furthermore, the user or supplier of the battery pack may be shown an indication of the faulty cells so that the user or supplier can repair and/or replace the battery cell layer or the battery pack in which the faulty cells are located.

The temperature sensors may be associated with the busbars of the battery cell layers. For example, the temperature sensors may be distributed across the busbars. Temperature sensors may be provided on an inner face of the busbar (e.g. a face that is facing towards the centre of the battery cell layer associated with the busbar) and/or an outer face of the busbar (e.g. a face that is facing away from the centre of the battery cell layer associated with the busbar). Equally, temperature sensors may be associated with and/or provided on the gaskets or the scaffoldings of the battery cell layers. Indeed, as described above, typically the temperature sensors are located at, or associated with, the entrances and/or exits of channels of the scaffoldings.

The operation of the battery cells is typically dependent on the temperature of these cells, where the battery cells have a maximum optimal operating temperature. Therefore, the coolant is used to transfer heat away from the battery cells to the surroundings of the battery in order to avoid overheating. As well as having a maximum optimal operating temperature, the battery cells may have a minimum optimal operating temperature. Therefore, as shown in FIG. 18c, one or more heating elements 554 may be provided in the battery pack in order to transfer heat to the battery cells. These heating elements are usually activated at the start of the operation of the battery pack (e.g. when a user first starts the vehicle).

The battery pack may comprise a plurality of heating elements 554 distributed across the battery pack. More specifically, the battery pack may comprise a plurality of heating elements associated with the busbars of each battery cell layer of the battery pack. The heating elements are typically distributed across the busbars so that they provide heat evenly to the coolant throughout the battery pack. In this way, the distributed heating elements are arranged to provide even heating of the coolant (and therefore the battery cells).

The heating elements are typically arranged in dependence on the battery cells (or the cell receptacles 514), where there may, for example, be a heating element located between a plurality of cells or between each pair of cells.

As described above, the heating elements are typically provided on the busbar(s). Equally, the heating elements may be associated with and/or provided on the gaskets or the scaffolding parts 501a, 501b. Each scaffolding part may be associated with its own plurality of heating elements to ensure even heating across the whole of the battery.

Where heating elements are provided on the busbar(s), the heating elements may be provided on an inner face of the busbar (e.g. a face that is facing towards the centre of the battery cell layer associated with the busbar) and/or an outer face of the busbar (e.g. a face that is facing away from the centre of the battery cell layer associated with the busbar).

Providing distributed heating elements rather than a single heating element leads to uniform heating throughout the battery pack and so avoids undesirable hotspots and related safety risks. The use of a dielectric coolant enables the heating elements 524 to be exposed to the coolant, enabling a plurality of heating elements to be provided, and enabling these heating elements to be provided within the battery cell layers and close to the battery cells.

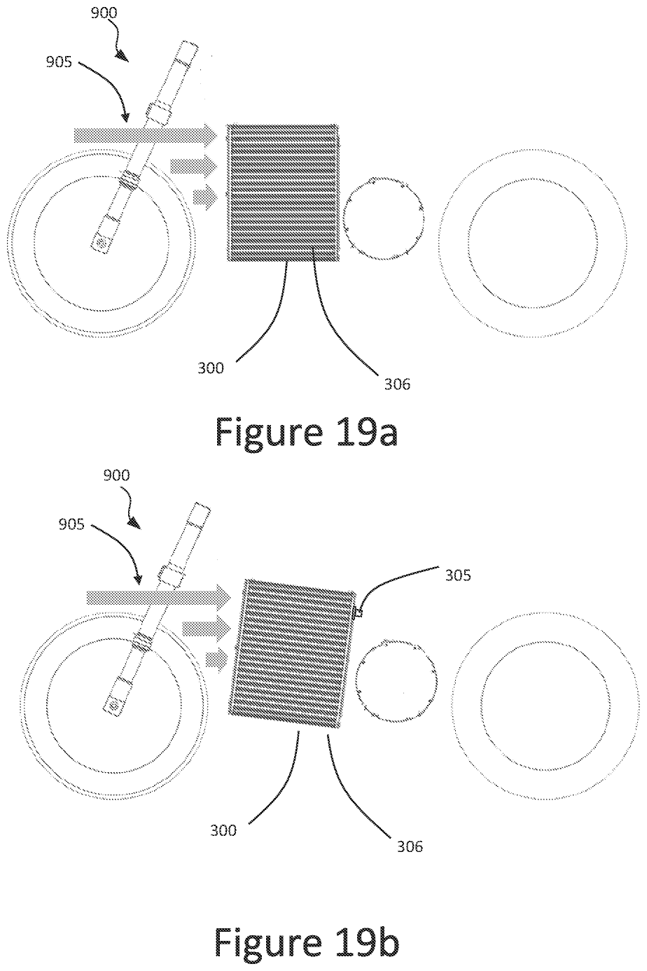

An example of a vehicle 900 comprising the battery pack 300 of the present disclosure is shown in FIGS. 19a and 19b. The vehicle 900 in this example is a two-wheeled vehicle, such as a motorcycle or scooter but the battery pack may be used in any vehicle type (for example, the battery pack may be used in a marine vehicle, where the battery pack may be arranged so that water flows over the fins 306). The air flow 905 as the vehicle travels forwards is illustrated in the figure. The battery pack 300 is orientated such that the fins 306 align with the direction of airflow, further enhancing the function of the housing 310 as a heat exchanger for the battery pack 300. FIG. 9B shows the battery pack 300 inclined, such that the back surface of the battery pack, to which the pump 303 is mounted, is angled from the vertical towards the horizontal. This provides the incline to the pump 305 as discussed above, further reducing the chances of air bubbles affecting the pump and causing potentially damaging dry pumping. This can therefore provide improved durability and reduced servicing and replacement requirements for the pump. In this example the fins 306 have also been angled, however the housing could be constructed such that when the battery pack is mounted at an incline the fins run parallel with a ground plane.

The liquid coolant that circulates inside the battery pack is a dielectric fluid. The liquid coolant is an electrically non-conductive but thermally conductive fluid. The coolant is initially channelled through one or more chambers within the housing, where it flows past the battery cells housed in these chambers. Once the coolant leaves these chambers it is then channelled across the inner surface of the battery housing—to transfer heat to the housing and thereby cool the coolant down—before it is then pumped back into the cell chambers.

The housing is made of aluminium with ribbing on the inside and fins on the outside. The ribs on the inside increase the surface area for heat transfer from the coolant to the aluminium. The fins on the outside increase the surface area for heat transfer from aluminium housing to the external environment or surrounding air.

The fins are exposed to horizontal airflow when the vehicle is moving, extracting heat from the housing (in a motorcycle or small vehicle we can expose the battery system directly avoiding the need for a separate radiator). In some arrangements, fans can be installed onto or proximal to the housing to drive air past the fins if natural air flow is not sufficient. In other arrangements the fins can be removed from the outside of the housing and instead thermoelectric plates, liquid cooling plates, heat-pipes or any other similar thermal management systems can be installed onto or proximal to the housing to dissipate heat from the surface of the housing.

The thermal capacity of the liquid coolant provides a much greater reduction in overall temperature rise than if the system were filled air.

A heater, such as a resistive heater, can also be embedded inside the housing to heat the liquid coolant as it circulates internally. This is particularly useful when the battery is operating at a low temperature.

The volume of the housing that is not contained within the chambers is configured to be kept small within operational limits, this reduces the amount of coolant required, which reduces weight and the volume fluctuations that may be accounted for in the design.

An example of a suitable coolant liquid is the Novec 7300 Engineered Fluid which is available from 3M.

Recycling

A process for recycling battery packs will now be described.

The battery packs described above may be manufactured so as to have improved recyclability over battery packs known in the art. The process of recycling the battery pack is dependent upon its configuration.

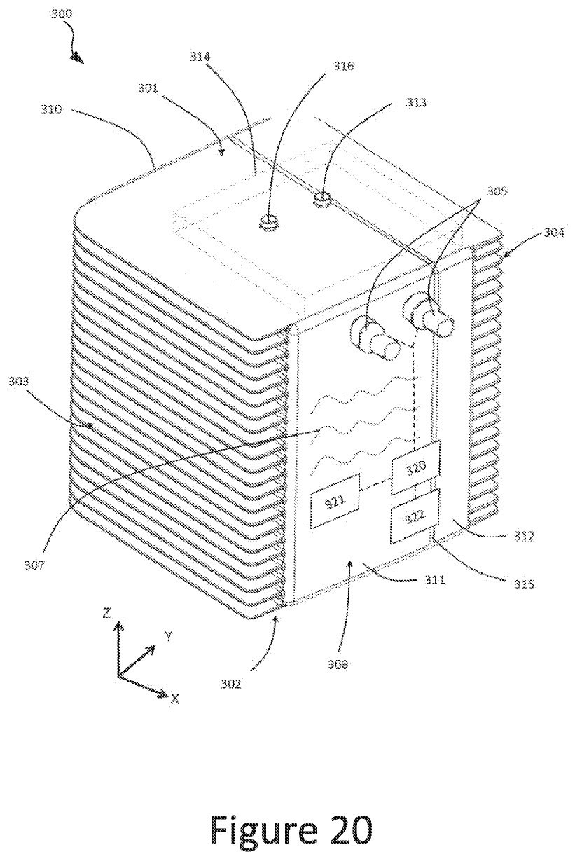

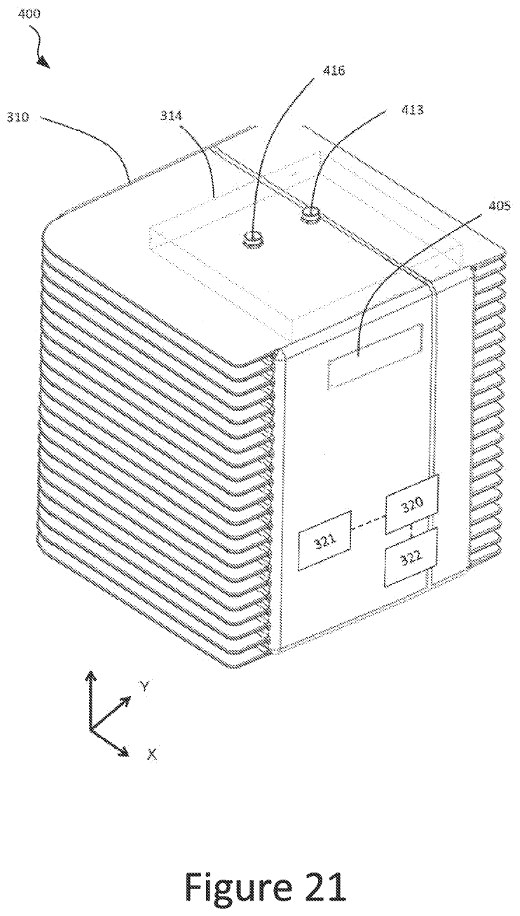

FIG. 20 shows a configuration of a battery pack 300 such as the battery pack of FIG. 3. The burst disc 316 is shown on the top surface. A post-recycling configuration of the battery pack is shown in FIG. 21. The battery pack is now an air-cooled battery pack 400. The pressure relief valve or vent 313 and burst disc 316 have been replaced with respective pressure relief valve or vent 413 and burst disc 416. The replacement components 413, 416 are configured for use in air-cooled situations and have different specifications to the original components 313, 316. The original components 313, 316 are of higher specification and configured for use in liquid-cooled battery packs. Their use in an air-cooled battery pack can be either unsuitable or over-specified. There is therefore more value in reusing the original components 313, 316 in a further, liquid-cooled battery pack and replacing them with more suitable and/or lower specification components suitable for use in the air-cooled battery pack 400. The pumps 305 are also removed and replaced with a cover 405 to seal the apertures left by removal of the pumps 305.

In some examples the pumps 305 may be replaced with air pumps instead of the cover. In other examples one or more pumps may be replaced with air pumps and one or more pumps may be covered. In some examples only the pumps are replaced, along with the removal of the coolant liquid.

Using air pumps and removing the coolant liquid provides the battery pack with means to be operated as an air-cooled battery pack with forced convention. The structure of the battery pack being arranged to have contact between the cells and the fluid within the battery pack makes this conversion particularly effective. This is because the air can flow directly over the surface of the cells, in place of where the coolant liquid used to flow. In water-cooled systems the cells are not in contact with the coolant (i.e. the water) and so replacement of the coolant with air would not be as effective.

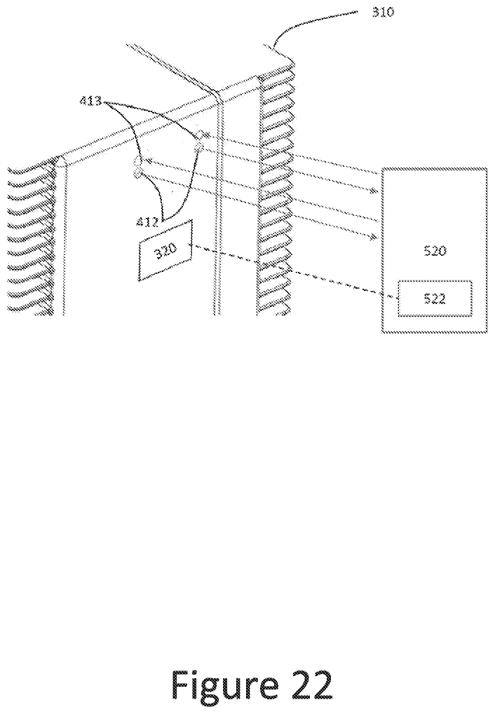

The fluid communication between the battery pack 300 and liquid recovery equipment 520 is shown in FIG. 22. With the removal of the pumps 305 inlet and outlet apertures 412, 413 are revealed. The liquid recovery equipment 520 is placed into fluid communication with the battery pack via the apertures. The liquid recovery equipment 520 is configured to pump in air and pump out the coolant liquid 307. A connection is made between the outlet 413 and the liquid recovery equipment 520 to enable the sucking out of the coolant liquid from the battery pack 300. A connection is made between the outlet 412 and the liquid extraction apparatus 520 to enable the pumping in of air into the battery pack 300. Multiple connections can be made, using either the various inlet and outlet apertures 412, 413 left behind from the removal of multiple pumps, of from the removal of other components, such as the pressure relief valve or vent, or the burst disc.

While FIG. 22 shows the inlet and outlet apertures 412, 413 as being located in close proximity, it will be appreciated that these apertures may be located further apart. For example, the inlet and outlet apertures may be located on opposing sides and/or opposing end plates of the battery pack. Similarly, the inlet and outlet apertures may comprise the vent 539 and/or the reversibly sealable hole 543.

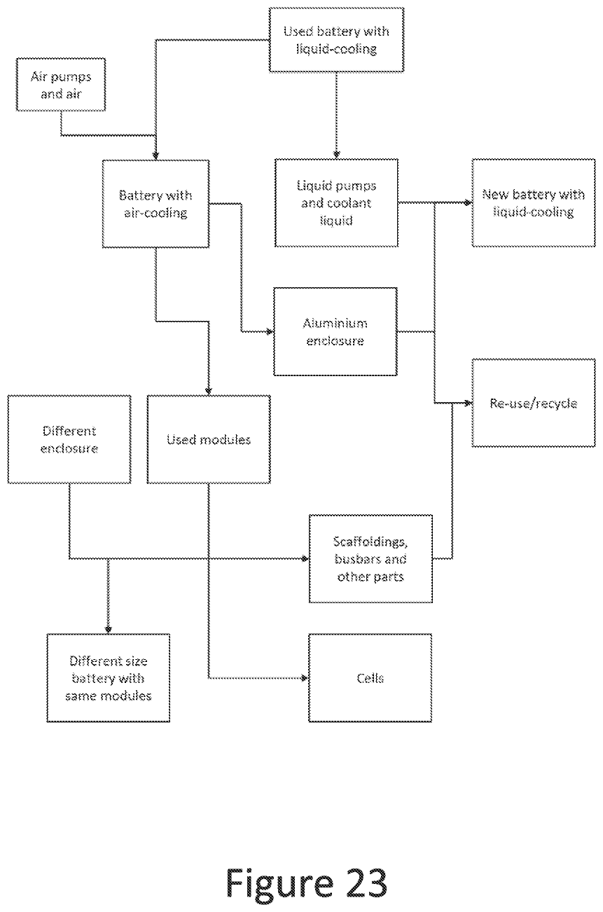

FIG. 23 provides an example overview of some of the recycling and reuse routes that can be taken with the battery packs described above. A liquid-cooled battery pack reaches the end of its current use phase and various recycling and reuse pathways can then be implemented.

Various ways of reusing the battery pack and its components are envisaged. These pathways include modifying the battery pack in order to repurpose it for another use case and reusing one or more of the components of the battery pack in a further liquid-cooled battery pack.

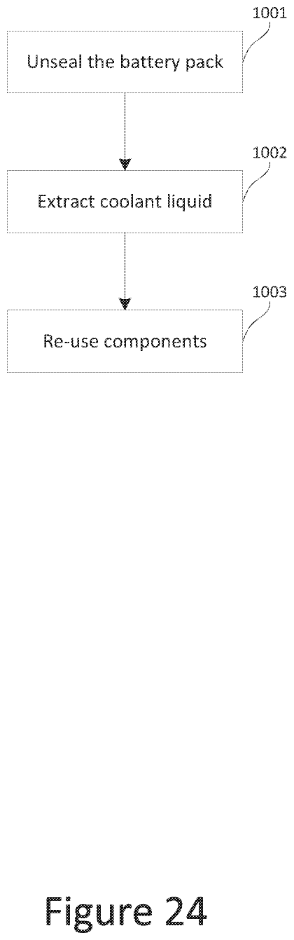

FIG. 24 shows the process steps in a method of recycling a battery pack. In a first step 1001 the battery pack is unsealed. In this example unsealing the battery pack comprises the removal of one or more components fitted to or through the wall of the housing. Once unsealed the liquid coolant can be extracted from within the housing. Extracting the coolant liquid is the second step 1002. The third step comprises re-using one or more of the components of the liquid-cooling system of the battery pack in a further battery pack. The liquid-cooling system comprises the coolant liquid at least and can also comprise the pumps.

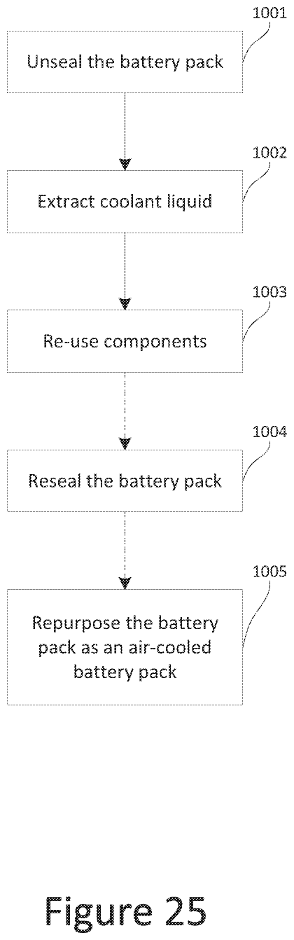

If the battery pack is to be re-used then an optional fourth step 1004 is enacted, as shown in FIG. 25. The fourth step comprises resealing the battery pack. Resealing the battery pack protects the cells and other internal components from the environment whilst still allowing the battery pack to be operated in an air-cooled mode of operation. A fifth step 1005 can then be implemented, repurposing the battery pack as an air-cooled battery pack.

Thus, we produce an air-cooled battery in the same housing as was used for the liquid-cooled battery pack without having to take the battery cells out of the housing. This allows us to use the same housing as a transport container to carry the battery cells to their new position (geographic position) of use. Once the recycling process is complete the battery pack can therefore be transported as a single unit, as a functional battery pack. There is no requirement to extract the battery cells, store them, transport them and then rehouse in a new carrier, as required in current recycling solutions known in the art. The cells are not removed, taken to another place and inserted into a housing. Instead, the cells are already in a box/housing that can just be picked up. In some examples the scaffolding remains in place so as to continue to secure and space the cells. It also avoids us having to disconnect electrical leads from the battery cells and connect new ones—for example the leads connecting the battery cells to a busbar, and the busbar to an electrical input and output terminal. This saves a lot of time and expense, and waste materials. The air-cooled battery has the same battery cells connected by the same leads to the same busbars and electrical terminals.

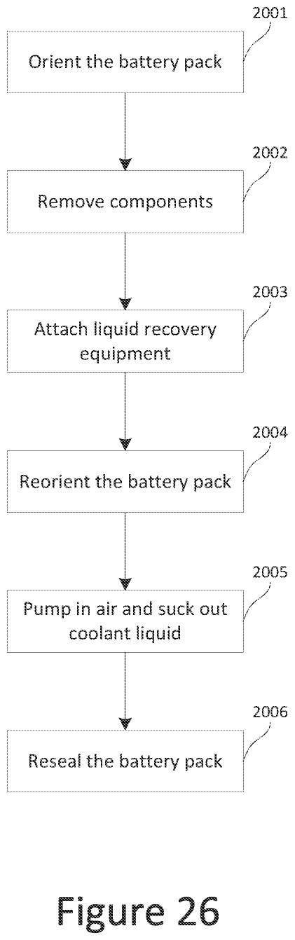

The step of extracting 1002 the coolant liquid can be broken down into multiple constituent steps. These steps are shown in FIG. 26. A first step 2001 comprises orientating the battery pack. The battery pack is orientated such that the components to be removed to unseal the battery pack are located at the top of the battery pack. For example, if the pumps are to be removed and to provide the unsealing and extraction points then the battery pack is rotated such that the back 308 of the battery pack is facing upwards. The relevant components are then removed 2002 in the second step. The components are removed through undoing bolts securing the components to the housing and then detaching the components and taking the gasket away that provided the seal between the components and the housing wall. Removing the components reveals apertures in the housing of the battery pack. Liquid recovery equipment can then be attached 2003 to the battery pack in a third step. The liquid recovery pack is attached so that it is in fluid communication with the inside of the housing, through the apertures. The same bolts and gasket used for the components attached to the housing can be re-used to attach the liquid recovery equipment to the housing. The liquid recovery equipment is operable to pump air into the battery pack and pump liquid coolant out of the battery pack. The fourth step 2004 is to reorient the battery pack so that the apertures with the liquid recovery equipment to them are now facing downwards. The fifth step 2005 is to then enact said pumping. The air pumped in is dry air and provides a positive pressure (or at least a less severe negative pressure than if air was not pumped in) to facilitate the pumping out of the coolant liquid. The air is dried by the liquid recovery apparatus. The apparatus draws in ambient air and passes it through a dehumidifier before pumping into the battery pack. Once the liquid coolant is removed and the air has been pumped in then the liquid recovery apparatus can be removed and the battery pack resealed 2006. Resealing the battery pack may comprise fitting covers to the apertures, or other sealing means. This may be a welded cover or a bolted cover with a gasket to ensure sealing. New components may instead be fit to replace the original components. The original liquid pumps can be replaced with air pumps for example. Using air pumps allows for forced convention within the battery pack. Heat transfer will be reduced over a liquid-cooled battery pack but still be improved over a passive air-cooled battery pack, as would be provided by the fitting of covers. With both the fitment of covers and replacement of components the original bolts and gaskets can be reused. An inspection step may be implemented in order to ensure the gaskets still provide a sealing fit.

In some variations of the method multiple components are removed, providing multiple apertures for the liquid recovery apparatus to be attached to. Increasing the number of connections can increase fluid flow—both coolant liquid out and air in.

Completion of the extraction is detected using a senor. The sensor detects when a sufficient amount of liquid is extracted. Whether the amount of liquid extracted qualifies as a sufficient amount is dependent at least in part on the next use case for the battery pack. There may still remain some remnants of the liquid in the system; sufficient extraction may be defined as recovering at least 95% of the liquid. If the battery pack is to be fitted with air pumps in order to be operated as a forced air-cooled battery pack then substantially all of the liquid should be extracted such that the air pumps are not affected by the presence of liquid within the battery pack. If the battery pack is to be used as a passive air-cooled battery pack then there can be more tolerance for leftover coolant liquid. As an objective of extracting the coolant liquid is to reuse it then the amount of coolant liquid extracted is prioritised. The sensor is the liquid level sensor on the battery pack. Alternatively a further liquid sensor can be used as well or instead. The further liquid sensor is a component of the liquid recovery apparatus. The further liquid sensor may comprise a sensor on the pumps pumping the liquid out of the battery pack, and may be configured to detect when the pumps are dry pumping. Dry pumping is indicative that the coolant liquid has been removed and so the pumping can be stopped. Another possible sensor could be a weight sensor, with the weight of the extracted liquid being determined.

Once pumping is complete the sensor passes a signal to the controller to switch a mode of operation of the controller to either a forced air-cooled mode or a passive air-cooled mode. The controller controls the battery pack to have a different charge and discharge performance when it is air-cooled than when it was liquid-cooled.

The components removed in this example are the pumps. Other suitable components for removal include the reservoir, pressure relief valve or vent and burst disc Where each of the components are removed they are either refitted or replaced with an alternative component suited for the requirements of an air-cooled battery pack. This may simply be a cover, or a less complex pressure management system, as an air-cooled battery pack does not have the problems associated with liquid coolant being present, such as having to accommodate large volume changes in the liquid coolant in high temperature scenarios.

The components removed from the battery pack can then be repurposed into a further battery pack. The removed components usually have a longer serviceable life than the cells, and so can be reused with new cells in a new battery pack, therefore reducing the components and manufacturing costs of the new battery pack, as well as reducing the CO2 footprint of the battery packs.

The controller is configured to operate in one of a plurality of modes. The controller in this example is operable in one of three modes: a first mode is a liquid-cooled mode; a second mode is a forced air-cooled mode and a third mode is a passive air-cooled mode. The liquid-cooled mode is the mode in which the battery pack operates when it is filled with the coolant liquid. This first mode is the mode that the battery pack operates in in a first phase of its lifecycle. In the forced air-cooled mode the liquid pumps are replaced with air pumps. The passive air-cooled mode is used when the pumps are replaced with a simple cover. The passive air-cooled mode may be used after or instead of the forced air-cooled mode. In other words, the lifecycle of the battery pack may begin with liquid-cooled and then move to forced air-cooled and finally passive air-cooled. Alternatively, the battery pack's life cycle may begin with liquid-cooled and then move to forced air-cooled or passive air-cooled. Which mode is chosen may be dependent upon the effectiveness of the cells at that point in the lifecycle. For example, if the cells are still able to operate at medium power requirements then it may be viable to configure the battery pack to operate in a forced-air-cooled mode. However, if the cells are only suitable for low-power requirements then it may be more economically viable to operate the battery pack in a passive air-cooled mode. As the cells can only discharge at a low rate, overheating becomes less likely and the additional cost and complexity of fitting air pumps is not required.

In some configurations of the battery pack the pumps of the battery pack itself are used to suck the liquid out of the enclosure outlet hole

Switching the controller between modes may be implemented either by the liquid sensor as described above or by various other means. For example, as part of the recycling process a signal may be provided. The signal could be provided over Bluetooth (RTM) or other wireless signal, or via a wired connection to the controller. A simple toggle switch may also be provided to switch the controller between modes. The recycling process may comprise re-flashing the controller with new parameters and/or operating conditions to fit with the intended end purpose, dependent upon how the battery pack is modified during the recycling process.

Various modifications can be made to the examples and embodiments described above without departing from the scope of the appended claims. For example, where parts fit together in a male/female relationship it is also envisaged that the relationship is reversed. Features of the examples and embodiments may be exchanged, combined, omitted or adapted. The teaching of the specification should be taken as a whole with no limitation placed on the scope of the appended claims by reference to the included description and drawings.

As described above, the coolant may be extracted from the battery with the battery being reusable as an air-cooled battery. The modification of the battery to an air cooled battery may comprise the pump being changed for an air pump. This may comprise an end plate of the battery being changed. In particular, a ‘normal’ bottom end plate may be removed from the battery and an air-cooling bottom end plate may be added to the battery, which air-cooling bottom end plate comprises an air pump. This air-cooling bottom end plate is typically similar to the normal bottom end plate apart from the pump. In some embodiments, a vent is provided on the air-cooling bottom end plate, but no reservoir is provided—this is because with an air cooled battery air may be allowed to pass freely through the vent as the air inside the battery expands and contracts and there is no need to provide an expansion volume for a liquid coolant.

In some embodiments, the pump 305 is detachable from the battery pack and/or from the bottom end plate 532. This enables the simple exchange of a liquid pump for an air pump so that the battery pack can more easily be repurposed as an air-cooled battery.

In some embodiments, the battery pack and/or the bottom end plate 532 is provided with both a liquid pump and an air pump. Therefore, once the coolant has been extracted the battery may be optimised for use with air simply by switching an operation mode of the battery pack (where different operation modes use different pumps).

Where the methods of FIGS. 24, 25, and 26 refer to the battery pack being unsealed, this unsealing may comprise unsealing the reversibly sealed hole 543. Where such a reversibly sealed hole is provided, the battery pack may be left substantially intact throughout the recycling process. The re-sealing of the battery pack may then comprise re-sealing the reversibly sealed hole.

1. A battery pack comprising:
a first battery cell layer comprising a structure for locating battery cells and providing a flow path for a coolant so that the coolant passes across the battery cells;
a gasket of a first gasket type located adjacent a first face of the first battery cell layer; and
a gasket of a second gasket type located adjacent a second face of the first battery cell layer;
wherein each of the first gasket type and the second gasket type comprises a first side and a second side; and wherein:
the first gasket type comprises holes for the coolant located on the first side of the first gasket type; and
the second gasket type comprises holes for the coolant located on the second side of the second gasket type;
whereby the gaskets enable the coolant to flow from a first end of the battery pack to a second end of the battery pack via the flow path.

2. The battery pack of claim 1, comprising a plurality of battery cell layers, wherein each battery cell layer comprises a structure for locating battery cells and providing a flow path for a coolant so that the coolant passes across the battery cells.

3. The battery pack of claim 2, wherein at least two of, and/or each of, the plurality of battery cell layers have a gasket of the first gasket type located adjacent a first face of said layer and a gasket of the second gasket type located adjacent a second face of said layer.

4. The battery pack of claim 1, wherein the first face and the second face are opposing faces.

5. The battery pack of claim 2, wherein at least one pair of, and/or each pair of neighbouring battery cell layers has a gasket of a third gasket type located between said pair of battery cell layers, wherein the third gasket type comprises holes for the coolant located on both the first side and the second side of the third gasket type.

6. (canceled)

7. (canceled)

8. (canceled)

9. The battery pack of claim 1, wherein each battery cell layer comprises a scaffolding.

10. (canceled)

11. The battery pack of claim 9, wherein each scaffolding comprises a plurality of channels, wherein each channel is arranged to locate a plurality of battery cells and to provide a flow path for a coolant so that the coolant passes across the cells.

12. The battery pack of claim 11, wherein the gaskets are arranged such that coolant is able to flow through the holes in each gasket and into and/or out of the channels of the scaffolding of each battery cell layer.

13. The battery pack of claim 11, wherein the scaffoldings and the gaskets are together arranged to define a flow path for the coolant.

14. (canceled)

15. The battery pack of claim 1, being arranged such that the pressure of the coolant at the first side of the battery pack is greater than the pressure of the coolant at the second side of the battery pack, such that the coolant flows from the first side of the battery pack to the second side of the battery pack.

16. The battery pack of claim 1, comprising an enclosure, wherein each battery cell layer and each gasket is located within the enclosure, wherein each battery cell layer comprises a housing segment, wherein the housing segments are arranged to cooperate so as to form part or all of the enclosure of the battery pack, wherein:
the housing segment of each battery cell layer comprises a structure for locating a gasket adjacent said housing segment; and/or;
the gaskets between each pair of battery cell layers form a seal between said pair of battery cell layers and/or a seal between a/the housing segments of said pair of battery cell layers.

17. (canceled)

18. (Canceled)

19. (canceled)

20. The battery pack of claim 1, comprising a first end plate, wherein:
the first end plate is located adjacent to a gasket of the first type or a gasket of the second type; and/or
wherein the first end plate comprises a structure for locating a gasket adjacent the first end plate such that said gasket forms a seal between the first end plate and one of the battery cell layers.

21. (canceled)

22. The battery pack of claim 20, wherein the first end plate comprises one or more of:
a reservoir arranged to accommodate an expansion of the coolant due to temperature fluctuations when the battery pack is in use; and
a vent arranged to:
provide an outlet for air to accommodate expansion of the coolant when the temperature of the coolant increases; and/or
provide an inlet for air to accommodate compression of the coolant when the temperature of the coolant decreases;
a pump, which pump is arranged to promote the flow of the coolant through the battery pack; and
vanes to promote the transfer of heat from the first end plate to the surroundings of the battery pack.

23. The battery pack of claim 20, wherein the first end plate comprises a plurality of first end plate channels, wherein the first end plate channels correspond to channels in the battery cell layer(s), and wherein the first end plate channels are arranged such that the coolant is able to flow from a/the pump to the holes of a gasket, via the first end plate channels.

24. The battery pack of claim 23, wherein the first end plate channels are arranged such that, in use, the volumetric flow rate of the coolant through each of the first end plate channels is substantially the same.

25. (canceled)

26. (canceled)

27. (canceled)

28. (canceled)

29-38. (canceled)

39. The battery pack of claim 1, wherein one or more of the gasket types, and/or each of, the gasket types comprises a fluid return hole, wherein the battery pack is arranged such that the coolant is able to flow from the second end of the battery pack to the first end of the battery pack via the fluid return holes.

40-45. (canceled)

46. The battery pack of claim 1, comprising one or more temperature sensors and/or comprising one or more temperature sensors located at the exits and/or entrances of one or more channels of one or more battery cell layers.

47. (canceled)

48-54. (canceled)

55. The battery pack of claim 1, comprising a plurality of heating elements, wherein the heating elements are distributed across the battery pack so as to provide even heating of the coolant.

56-97. (canceled)

98. A kit of parts for a battery pack, the kit of parts comprising:
a first battery cell layer comprising a structure for locating battery cells and providing a flow path for a coolant so that the coolant passes across the battery cells;
a gasket of a first gasket type; and
a gasket of a second gasket type;
wherein each of the first gasket type and the second gasket type comprises a first side and a second side; and wherein:
the first gasket type comprises holes for the coolant located on the first side of the first gasket type; and
the second gasket type comprises holes for the coolant located on the second side of the second gasket type.

99-163. (canceled)

164. A vehicle comprising the battery pack of claim 1.
